(19) United States
(12) Patent Application Publication
(10) Pub. No.: US 2024/0287351 A1
(43) Pub. Date: Aug. 29, 2024

(54) ENGINEERED MULTIFUNCTIONAL PARTICLES AND THIN DURABLE COATINGS COMPRISING CROSSLINKED SILANE POLYMERS CONTAINING UREA

(71) Applicant: Bar-Ilan University, Ramat Gan (IL)

(72) Inventors: Shlomo MARGEL, Rehovot (IL); Elisheva SASON, Petach Tikva (IL); Eyal MALKA, Ra'anana (IL)

(21) Appl. No.: 18/024,816

(22) PCT Filed: Sep. 6, 2021
(86) PCT No.: PCT/IL2021/051093

§ 371 Date: Mar. 6, 2023

Related U.S. Application Data
(60) Provisional application No. 63/075,177, filed on Sep. 6, 2020.

(51) Int. Cl. C09D 183/08; B05D 1/18; B05D 1/36; C08J 7/04; C09D 5/14

(52) U.S. Cl. CPC C09D 183/08; B05D 1/18; B05D 1/36; C08J 7/0427; C09D 5/14; B05D 2518/12; C08J 2383/08

(57) ABSTRACT

Compositions comprising a silane-based polymer comprising a urea functional group and having a binding affinity to a biocide are disclosed. Coated substrates, particles and articles comprising the silane-based polymer are also disclosed. Process of preparing the compositions and methods of using the same, such as for inhibiting or reducing the formation of load of a microorganism in a plant or food product are provided.

### CROSS REFERENCE TO RELATED APPLICATIONS

This application claims the benefit of priority to U.S. Provisional Patent Application No. 63/075,177 filed Sep. 6, 2020, entitled “Engineered multifunctional nano/micro-particles and thin durable coatings composed of crosslinked silane polymers containing urea for controlled release of activated Cl, H₂O₂, essential oils and metal ions”, the contents of which are incorporated herein by reference in their entirety.

### FIELD OF THE INVENTION

The present invention relates generally to the field of compositions comprising one or more silane polymer containing urea and is directed to methods of using the same such as for coatings and for releasing different biocidal chemicals.

### BACKGROUND OF THE INVENTION

The re-emergence microorganism infections as well as the increased incidence of antimicrobial resistance among pathogenic bacteria constitute one of the paramount challenges facing humanity today, presenting a serious public health threat worldwide. The threat is particularly worrying in light of the few antimicrobial agents expected to enter the market in the near future. In the United States alone, around 2 million people acquire bacterial infections annually, resulting in 90000 deaths each year. In addition, the recent outbreak of corona virus infectious disease 2019 (COVID19) has gripped the world with apprehension and has evoked a scare of epic proportion regarding its potential to spread and infect humans worldwide. This highlights the need to develop novel antimicrobials and find innovative and creative solutions to inhibit bacterial, fungi and virus growth.

### SUMMARY OF THE INVENTION

In one aspect of the invention, there is provided a coated substrate comprising: a substrate, and a silane-based polymer having a binding affinity to a biocide, wherein: i) the silane-based polymer is covalently bound to at least a portion of the substrate, forming a coating layer; and ii) the silane-based polymer is represented by or comprises Formula I:

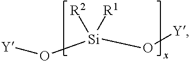

wherein: x represents an integer between 2 and 10.000; each Y′ independently represents H or a covalent bond to the substrate; R² comprises any one of: a urea functional group, and a urea derivative; R¹ represents hydrogen, or is selected from the group comprising

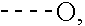

optionally substituted C₁-C₆ alkyl, —O(C₁-C₆ alkyl), —OH, or a combination thereof, [symbol] represents a covalent bond to i) the substrate, or ii) to an adjacent monomer; and wherein the silane-based polymer comprises at least one covalent bond to the substrate.

In some embodiments, the binding affinity is via formation of a covalent bond, a coordinative bond or a non-covalent bond between the biocide and the urea functional group.

In some embodiments, R² is represented by or comprises Formula II:

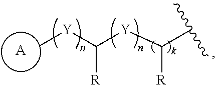

wherein: A comprises the urea functional group, the urea derivative or both; each Y independently represents a heteroatom, C, CH, CH₂, —CHR1-, —CR1R1-, or is absent; the heteroatom is selected from the group consisting of O, S, NH, and NR1, or a combination thereof, each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, the urea derivative comprises a urea metal complex, an n-halo urea, or any combination thereof.

In some embodiments, R² is represented by or comprises Formula IIa:

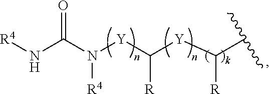

wherein each R⁴ represents hydrogen, halo, or —(CH)ₙSi(OR′)₃, wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; or wherein R⁴ is absent, and the urea group is coordinatively bound to a metal cation.

In some embodiments, the silane-based polymer is represented by or comprises Formula III:

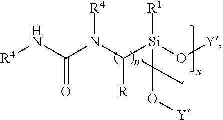

wherein n is an integer ranging from 1 to 5.

In some embodiments, the silane-based polymer is represented by or comprises Formula IV:

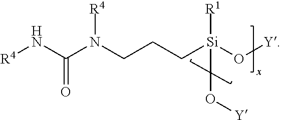

In some embodiments, the substrate comprises an at least partially oxidized surface comprising a plurality of hydroxy groups.

In some embodiments, the biocide comprises a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

In some embodiments, the essential oil is selected from the group comprising thymol, arginol, lemonene, cinnamon oil, organum oil, sage oil, tea tree oil, carvacrol oil, or any combination thereof.

In some embodiments, the metal ion is selected from the group comprising Zn²⁺, Cu²⁺ or Ag⁺.

In some embodiments, the coating layer is a mesoporous coating layer.

In some embodiments, the coating layer is characterized by a dry thickness between 0.1 μm and 50 μm.

In some embodiments, the coated substrate comprises at least two of the coating layers.

In some embodiments, the coating layer comprises an antimicrobial effective amount of the biocide.

In some embodiments, the antimicrobial effective amount comprises any of: (i) between 10 μmoles/1 cm² and 100 μmoles/1 cm² of chlorine; (ii) between 2 μmoles/14 cm² and 100 μmoles/14 cm² of H₂O₂ or both (i) and (ii).

In some embodiments, the coating layer comprises at least two distinct biocide species.

In some embodiments, the coating layer comprises Cl and an essential oil.

In some embodiments, the coating layer comprises a metal ion and hydrogen peroxide at a weight per weight (w/w) ratio between 1:500 (w/w) and 1:2000 (w/w).

In some embodiments, the substrate is selected from the group consisting of: a polymeric substrate, a metallic substrate, a paper substrate a glass substrate, and any combination thereof.

In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof.

In some embodiments, the metallic substrate comprises a metal oxide selected from the group consisting of iron oxide, titanium oxide, titanium dioxide, silica, alumina, hafnium oxide, zinc oxide, copper oxide and aluminum oxide.

In some embodiments, the coated substrate is characterized by a water contact angle on the surface of the coating layer between 400 and 110°.

In some embodiments, the coating layer is configured to release an antimicrobial effective amount of the biocide to an ambient, and wherein the coating layer is any of: an antimicrobial coating, synergistic antimicrobial coating, antibiofilm coating, bacteriostatic coating, fungicidal coating, fungistatic coating, pesticide coating, antiviral coating, or any combination thereof.

In some embodiments, an outer surface of the coating layer is further bound to an additional coating layer being substantially gas impermeable, optionally wherein the additional coating layer is removable.

In another aspect of the invention, there is provided an article comprising the coated substrate of the present invention.

In some embodiments, the article is selected from the group consisting of: plastic surface, metallic surface, package, and windows.

In another aspect of the invention, there is provided a process for obtaining a coated substrate, comprising the steps of: (a) providing at least partially oxidized substrate comprising a plurality of hydroxy groups; and (b) contacting the substrate with a composition comprising: (i) a silane-based monomer, wherein the silane-based monomer is represented by or comprises Formula V:

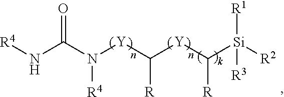

wherein: each of R¹, R², R³ independently represents hydrogen, or is selected from the group comprising optionally substituted C₁-C₆ alkyl, —O(C₁-C₆ alkyl), —OH, or a combination thereof, wherein at least one R¹, R² or R³ represents the substituent; each R⁴ independently represents hydrogen, halo, or —(CH)ₙSi(OR′)₃, wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; each Y independently represents a heteroatom, C, CH, CH₂, —CHR1-, —CR1R1-, or is absent; the heteroatom is selected from the group consisting of O, S, NH, and NR1, or a combination thereof; each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (ii) a solvent, a surfactant or both, under conditions suitable for the silane-based monomer to polymerize and covalently bound to the substrate, thereby forming a coating layer on the substrate.

In some embodiments, the process further comprises a step of contacting the coating layer with a biocide comprising a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

In some embodiments, the coated substrate is the coated substrate of the present invention.

In some embodiments, the process further comprises a step (c) of washing the substrate to remove non-bound silane-based monomer.

In some embodiments, the contacting is selected from the group comprising: dipping, spraying, spreading, casting, rolling, adhering, printing, curing, sonication, or any combination thereof.

In some embodiments, the silane-based monomer is represented by or comprises Formula VI:

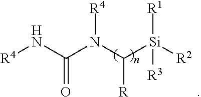

In some embodiments, the silane-based monomer is represented by or comprises any one of:

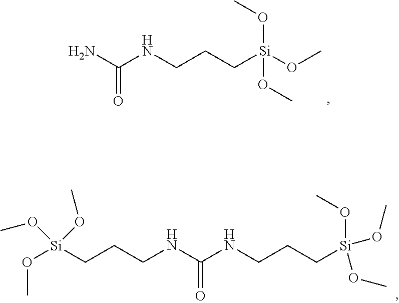

or both.

In some embodiments, the coating layer is characterized by a wet thickness between 1 μm and 2000 μm.

In some embodiments, the solvent is a protic solvent selected from the group consisting of: water, ethanol, methyl ethyl ketone, isopropanol, methanol, butanol and any combination thereof.

In some embodiments, the surfactant selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethyl ammonium bromide (DEDTAB), decyltrimethylammonium bromide (D10TAB), dodecyl triphenylphosphonium bromide (DTPB), polyvinylpyrrolidone (PVP), and any combination thereof.

In some embodiments, the composition comprises water and ethanol at a ratio between 1:2 and 1:20.

In some embodiments, the composition comprises between 5 mM and 40 mM of a base selected from NH₄OH, KOH, NaOH, or a combination thereof.

In some embodiments, the composition comprises between 0.01% weight per volume (w/v) and 5% (w/v) of the surfactant.

In some embodiments, the composition comprises between 0.1% (w/v) and 20% (w/v) of the silane-based monomer.

In some embodiments, the substrate is selected from the group consisting of: a polymeric substrate, a metallic substrate, a paper substrate, a glass substrate, and any combination thereof.

In another aspect of the invention, there is provided a composition comprising a plurality of modified metal oxide particles, wherein each particle comprises a core and a shell, wherein: i. the particle is characterized by an average diameter between 10 nm and 400 nm; ii. the shell is covalently bound to at least a portion of the core; and iii. the shell comprises a silane-based polymer represented by Formula I:

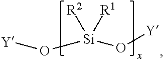

wherein: x represents an integer between 2 and 10.000; each Y′ independently represents H or a covalent bond to the core; R² comprises a urea functional group, or a urea derivative; R¹ represents hydrogen, or is selected from the group comprising

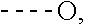

optionally substituted C₁-C₆ alkyl, —O(C₁-C₆ alkyl), —OH, or a combination thereof; [symbol] represents a covalent bond to i) the core, or ii) to an adjacent monomer; and wherein the silane-based polymer comprises at least one covalent bond to the core, and wherein the silane-based polymer has a binding affinity to a biocide.

In some embodiments, the core comprises a metal oxide particle.

In some embodiments, R² is represented by or comprises Formula II:

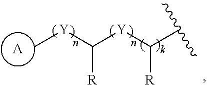

wherein: A comprises the urea functional group, or the urea derivative (such as a urea metal complex, an n-halo urea), or both, or wherein A represents the biocide non-covalently bound to urea; each Y independently represents a heteroatom, C, CH, CH₂, —CHR1-, —CR1R1-, or is absent; the heteroatom is selected from the group consisting of O, S, NH, and NR1, or a combination thereof, each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, R² is represented by or comprises Formula IIa:

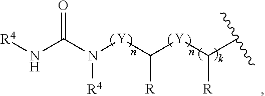

wherein each R⁴ independently represents hydrogen, halo, or —(CH)ₙSi(OR′)₃, wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl. In some embodiments, R⁴ is absent, and the urea group is coordinatively bound to a metal cation (e.g. an antibacterial metal cation).

In some embodiments, the silane-based polymer is represented by or comprises Formula III:

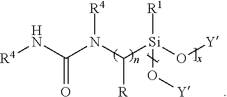

wherein n is an integer ranging from 1 to 5.

In some embodiments, the silane-based polymer is represented by or comprises Formula IV:

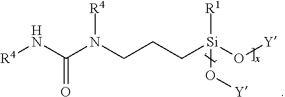

In some embodiments, the binding affinity is via formation of a covalent bond or a non-covalent bond to the urea functional group.

In some embodiments, the composition comprises an antimicrobial effective amount of the biocide bound.

In some embodiments, the biocide comprises a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

In some embodiments, the essential oil is selected from the group comprising thymol, arginol, lemonene, cinnamon oil, organum oil, sage oil tea tree oil, carvacrol oil, or any combination thereof.

In some embodiments, the metal ion is selected from the group comprising Zn²⁺, Cu²⁺ or Ag⁺.

In some embodiments, the composition comprises a protic solvent selected from the group consisting of: water, ethanol, methyl ethyl ketone, isopropanol, methanol, butanol and any combination thereof.

In some embodiments, the composition comprises water and ethanol at a volume per volume (v/v) ratio between 1:2 and 1:20.

In some embodiments, the composition comprises between 5 mM and 40 mM of a base selected from NH₄OH, KOH, NaOH, or a combination thereof.

In some embodiments, the composition comprises a surfactant selected from the group consisting of: cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyidimethyl ammonium bromide (DEDTAB), decyltrimethylammonium bromide (D10TAB), dodecyl triphenylphosphonium bromide (DTPB), polyvinylpyrrolidone (PVP), and any combination thereof.

In some embodiments, the composition comprises between 0.01% weight per volume (w/v) and 5% (w/v) of the surfactant.

In some embodiments, the composition is configured to release an antimicrobial effective amount of the biocide to an ambient, and wherein the composition is any of: an antimicrobial composition, synergistic antimicrobial composition, antibiofilm composition, bacteriostatic composition, fungicidal composition, fungistatic composition, pesticide composition, antiviral composition, or any combination thereof.

In another aspect of the invention, there is provided a method of inhibiting or reducing the formation of load of a microorganism in a plant or food product, the method comprising contacting the plant or the food product with the coated substrate of the present invention, the article of the present invention, or the composition of the present invention.

In some embodiments, the microorganism is selected from bacteria, yeast, mold, fungi, virus and any combination thereof.

In some embodiments, the coated substrate, the article and the composition release an antimicrobial effective amount of the biocide upon contacting thereof with the plant or the food product.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIGS. 1A-1B are a schematic representation of the process of producing the 4 different types of biocidal coatings (FIG. 1A) and nano/micro-particles (N\MPs) (FIG. 1B);

FIG. 2 presents the chemical structure of 1-[3-(trimethoxysilyl)propyl] urea (TMSPU);

FIG. 3 is a schematic representation of the Mayer rod system;

FIG. 4 presents the chemical structure of NTMSPU;

FIGS. 5A-5C present the chemical structure of Span 60 (FIG. 5A), Sarkosyl (FIG. 5B) and Merpol A (FIG. 5C);

FIG. 6 is a HR-SEM image of the core/shell SiO₂-urea particles (obtained as described in Table 8, experiment 4);

FIG. 7 is an attenuated total reflection (ATR) spectra of PE film (solid line), PE-SiO₂ propyl urea coating (dotted line), and PE-SiO₂ propyl urea coating after chlorination (dashed line);

FIGS. 8A-8B are ATR spectra of: PE film (solid line), PE/SiO₂-urea film (dotted line), PE/SiO₂-urea-H₂O₂ film (dashed line) (FIG. 8A); and PE/SiO₂-urea film (solid line), SiO₂-urea-H₂O₂ coating (dotted line) demonstrate the appearance of the hydrogen peroxide, 2830 cm¹ unique OH stretch (FIG. 8B); all the samples are PE films that prepared according to the procedure in Table 2, experiment 1 by spreading/rod-coating technique (Mayer rod 400 (Table 3), the hydrogen peroxide addition process was done at ˜55° C.;

FIG. 9 is a bar graph presenting anti-biofilm properties against HSV viruses of PE (control), PE/SiO₂-urea-Cl and PE/(SiO₂-urea-Cl+thymol) thin coatings after 1 h incubation at room temperature as described in the example section;

FIGS. 10A-10B are pictures of tobacco seedling, infected with the virus (ToBRFV) (positive control) (FIG. 10A) and tobacco seedling infected with virus after being inoculated in a PP/SiO₂-urea-Cl coating (FIG. 10B);

FIGS. 11A-11B are pictures of inflorescence Cannabis stevia wrapped by PE/SiO₂-urea-thymol films (FIG. 11A) and by PE/SiO₂-urea films (FIG. 11B) after 2 weeks in condition of above 80% humidity;

FIGS. 12A-12B are pictures of the development of molds on hay after two weeks in condition of above 80% humidity (FIG. 12A) PE/(SiO₂-urea-Cl), example 4 and PE film (FIG. 12B);

FIGS. 13A-13B are pictures of the development of molds on hay after 30 days in condition of above 60% humidity and 30° C. (FIG. 13A) PP control; and PP/SiO₂-urea-thymol 10% (FIG. 13B);

FIG. 14 is a picture of the experimental system including a beaker with plants, insects and a coated PP fabric; and

FIGS. 15A-15E are pictures of: fresh strain of tomato seedlings on a commercial tray (FIG. 15A); after transferring the trays treated with the differences SiO₂-urea coatings with and without chlorine and thymol (FIG. 15B); after growing for 8 days in the treated trays (FIG. 15C); root appearance of a fresh variety of tomato planted on a non-coated tray before (FIG. 15D) and after 8 days of growth in treated trays with silica coatings with and without chlorine and thymol 1% (FIG. 15E).

### DETAILED DESCRIPTION OF THE INVENTION

According to some embodiments, the present invention provides a silane-based polymer, comprising a urea functional group and having a binding affinity to a biocide.

According to some embodiments, the present invention provides a silane-based polymer, comprising a urea functional group, and a biocide bound to the silane-based polymer. In some embodiments, the biocide is bound to the urea functional group. The present invention is based, in part, on the finding that such silane-based polymer is characterized by biocidal activity against microorganisms. In some embodiments, a synergetic anti-microbial effect was achieved by combining different types of biocides.

According to some embodiments, the present invention provides a coated substrate comprising a substrate, a silane-based polymer, and a biocide. In some embodiments, the silane-based polymer is covalently bound to the substrate, forming a coating layer. In some embodiments, the silane-based polymer comprises a urea functional group, and a biocide bound thereto. In some embodiments, the coating layer imparts disinfectant properties to the substrate surface. As used herein, the term “disinfectant” refers to any chemical substance or compound used to inactivate or destroy microorganisms on inert surfaces.

According to some embodiments, the present invention provides a modified metal oxide particle comprising a core and a shell, wherein the shell is covalently bound to at least a portion of the core; and the shell comprises a silane-based polymer comprising a urea functional group. In some embodiments, the particle has a binding affinity to a biocide. In some embodiments, the particle comprises a biocide bound to the silane-based polymer. In some embodiments, the particle comprises a biocide bound to the urea functional group of the silane-based polymer.

In some embodiments, the coated substrate and modified metal oxide particle are for use in the release an antimicrobial effective amount of a biocide to the surrounding atmosphere. In some embodiments, the silane-based polymer of the invention is configured to substantially release the biocide bound thereto. In some embodiments, the silane-based polymer of the invention (and or the coating comprising thereof) is configured to substantially release the biocide bound thereto, wherein substantially is between 50 and 99%, between 50 and 70%, between 70 and 80%, between 80 and 90%, between 90 and 95%, between 95 and 99%, between 99 and 99.9%, between 90 and 100% by weight of the initial biocide content including any range between. In some embodiments, the silane-based polymer of the invention (and or the coating comprising thereof) is configured to substantially release the biocide bound thereto within a time ranging between 1 hour and 1 month, 1 h and 1 day (d), 1 and 5 d, 1 and 10 d, 5 and 10 d, 10 and 20 d, 1 and 20 d, 1 h and 5 d, 1 h and 10 d, 20 and 30 d, 30 and 60 d, including any range between.

The present invention is based, in part, on the finding that the silane-based polymer of the invention (or the coating comprising thereof, and/or modified metal oxide particle comprising thereof) is recyclable (e.g. after being released, the biocide can be re-loaded on the coating layer of the substrate or on the modified metal oxide particle). One skilled in the art will appreciate, that upon release of the biocide from the silane-based polymer of the invention (and/or coating comprising thereof), a free urea group is formed. Accordingly, free urea group has an affinity to the biocide and thus can be reacted with a biocide to result in the silane-based polymer of the invention bound to (or re-loaded with) the biocide, as described herein. The process of re-loading of the free urea group of the silane-based polymer is also referred to herein as “recycling cycle”, and the silane-based polymer of the invention (and/or the coated substrate comprising thereof) is also referred to herein as “recyclable”.

In some embodiments, the silane-based polymer of the invention (or a coated substrate and/or modified metal oxide particle as described herein) is recyclable for at least 2 times, at least 3 times, at least 5 times, at least 10 times, at least 20 times, or at least 50 times, without substantially altering its structural and/or functional properties (e.g. so as to substantially retain its biocidal properties).

In some embodiments, the silane-based polymer of the invention (or a coated substrate and/or modified metal oxide particle as described herein) is stable upon between 2 and 50 recycling cycles, between 2 and 10 recycling cycles, between 2 and 5 recycling cycles, between 5 and 10 recycling cycles, between 10 and 20 recycling cycles, between 20 and 30 recycling cycles, between 30 and 40 recycling cycles, between 40 and 50 recycling cycles, including any range between; wherein the term “stable” refers to the retention of at least 60%, at least 70%, at least 80%, at least 90%, at least 95%, of the biocidal activity of the silane-based polymer (or of a coated substrate and/or modified metal oxide particle comprising thereof). In some embodiments, the term “biocidal activity” refers to the ability of the silane-based polymer (or of a coated substrate comprising thereof) to release the biocide bound thereto.

In some embodiments, the coated substrate is substantially stable (e.g., the coated substrate substantially maintains its biocidal activity and/or structural and/or functional properties, such as stability of the coating layer, absence of disintegration or erosion of the coating layer) under for a time period between 1 d and 1 year (y), between 1 and 30 d, between 30 d and 60 d, between 60 d and 100 d, between 100 and 200 d, between 200 d and 1 y, including any range between. In some embodiments, the coated substrate is substantially stable under storage conditions comprising (i) a temperature ranging between −40° C. and 70° C., between −40° C. and 40° C., between −40° C. and 30° C., between −40° C. and 0° C., between 0° C. and 70° C., between 0° C. and 30° C., between 30° C. and 70° C., 30° C. and 50° C., between 50° C. and 70° C., including any range between; and (ii) exposure to atmospheric conditions, such as an ambient atmosphere, for a time period as described herein.

### Coated Substrates

According to an aspect of some embodiments of the present invention there is provided a coated substrate. In some embodiments, the coated substrate comprises a substrate, and a silane-based monomer covalently attached thereto. In some embodiments, the silane-based monomer has a binding affinity to a biocide. In some embodiments, the coated substrate comprises a biocide bound to the silane-based monomer.

In some embodiments, the coated substrate comprises a substrate, and a silane-based monomer, wherein: i) the silane-based monomer is covalently bound to at least a portion of the substrate, forming a coating layer, and ii) the silane-based monomer is represented by or comprises Formula Ia:

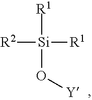

wherein R² comprises any of: a urea functional group, and a urea derivative; each R¹ independently represents hydrogen, or is selected from the group comprising optionally substituted C₁-C₆ alkyl, —O(C₁-C₆ alkyl), —OH, or a combination thereof, Y′ represents a covalent bond to the substrate. In some embodiments, a urea functional group or a derivative thereof comprises a urea bond to a biocide. In some embodiments, the bond is a covalent bond, a coordinative bond, or a non-covalent bond, between the biocide and the urea functional group. In some embodiments, the bond is a covalent bond, a coordinative bond, or a non-covalent bond, between the biocide and the carbonyl functional group. In some embodiments, the bond is a covalent bond, a coordinative bond, or a non-covalent bond, between the biocide and the silane group.

In some embodiments, the silane-based monomer is represented by or comprises Formula Ib:

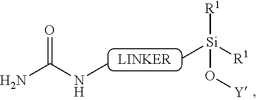

wherein each of R¹ independently represents hydrogen, or is selected from the group comprising optionally substituted C₁-C₆ alkyl, —O(C₁-C₆ alkyl), —OH, or a combination thereof, and Y′ represents a covalent bond to the substrate. As used herein “linker” refers to a molecule or macromolecule serving to connect different moieties or functional groups. According to the present invention, the linker is covalently bound to i) urea functional group, and ii) to the silane group. In some embodiments, linker comprises a group, molecule or macromolecule connecting the urea functional group to the silane group.

In some embodiments, the silane-based monomer is represented by or comprises Formula Ic:

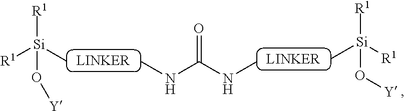

wherein each of R¹ independently represents hydrogen, or is selected from the group comprising optionally substituted C₁-C₆ alkyl, —O(C₁-C₆ alkyl), —OH, or a combination thereof, and each of Y′ represents hydrogen, or a covalent bond to the substrate, wherein at least one Y′ represents a bond to the substrate. As used herein “linker” refers to a molecule or macromolecule serving to connect different moieties or functional groups. According to the present invention, the linker is covalently bound to i) urea functional group, and ii) to the silane group. In some embodiments, linker comprises a group, molecule or macromolecule connecting the urea functional group to the silane group.

In some embodiments, the silane-based monomer is represented by or comprises Formula Id:

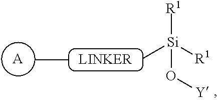

wherein A comprises a urea, a urea metal complex, an n-halo urea, or any combination thereof, each of R¹ independently represents hydrogen, or is selected from the group comprising optionally substituted C₁-C₆ alkyl, —O(C₁-C₆ alkyl), —OH, or a combination thereof, and Y′ represents a covalent bond to the substrate. In some embodiments, A comprises the urea functional group, the urea derivative or both.

As used herein, the term “halo”, “halo atom” or “halogen” refers to an atom selected from the group consisting of: chlorine, bromine, and iodine and fluorine.

In some embodiments, one or more hydrogens bound to a nitrogen atom in the urea functional group or derivative thereof (also termed herein throughout: “halogenated”) is replaced, by a halo atom. In some embodiments, the halogen atom independently selected from the group consisting of Cl, Br, I and F. In some embodiments, at least one halo atom is bound (also termed herein throughout as “attached”) to a nitrogen atom belonging to urea functional group or derivative thereof, as described herein.

According to an aspect of some embodiments of the present invention there is provided a coated substrate comprising: a substrate, and a silane-based polymer having a binding affinity to a biocide, wherein: i) the silane-based polymer is covalently bound to at least a portion of the substrate, forming a coating layer; and ii) the silane-based polymer is represented by or comprises Formula I:

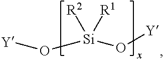

wherein: x represents an integer between 2 and 10.000; each Y′ independently represents H or a covalent bond to the substrate; R² comprises any of: a urea functional group, and a urea derivative; R¹ represents hydrogen, or is selected from the group comprising

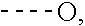

optionally substituted C₁-C₆ alkyl, —O(C₁-C₆ alkyl), —OH, or a combination thereof, [symbol] covalent bond to i) the substrate, or ii) to an adjacent monomer; and wherein the silane-based polymer comprises at least one covalent bond to the substrate.

In some embodiments, x represents an integer being between 2 and 1000, between 2 and 100, between 2 and 20, between 20 and 50, between 50 and 100, between 2 and 10.000, between 100 and 200, between 200 and 500, between 500 and 1000, between 1000 and 5000, or between 5000 and 10.000, including any range between. Each possibility represents a separate embodiment of the invention.

In some embodiments, a molar density of the urea functional group, and/or of the urea derivative relative to the substrate surface is between 0.1 μmoles/1 cm² and 1000 μmoles/cm², including any range between. In some embodiments, the coated substrate comprises an effective amount of the urea groups, wherein the effective amount is between 0.1 μmoles/1 cm² and 1000 μmoles/cm², between 0.01 μmoles/1 cm² and 0.1 μmoles/cm², between 0.1 μmoles/1 cm² and 0.5 μmoles/cm², between 0.5 μmoles/1 cm² and 1 μmoles/cm², between 0.1 μmoles/1 cm² and 10 μmoles/cm², between 0.1 μmoles/1 cm² and 20 μmoles/cm², between 0.1 μmoles/1 cm² and 40 μmoles/cm², between 1 μmoles/1 cm² and 10 μmoles/cm², between 1 μmoles/1 cm² and 20 μmoles/cm², between 1 μmoles/1 cm² and 40 μmoles/cm², between 10 μmoles/1 cm² and 40 μmoles/cm², between 40 μmoles/1 cm² and 100 μmoles/cm², between 0.1 μmoles/1 cm² and 100 μmoles/cm², between 0.5 μmoles/1 cm² and 100 μmoles/cm², between 0.5 μmoles/1 cm² and 10 μmoles/cm², between 100 μmoles/1 cm² and 200 μmoles/cm², between 200 μmoles/1 cm² and 500 μmoles/cm², between 500 μmoles/1 cm² and 1000 μmoles/cm², including any range between. Each possibility represents a separate embodiment of the invention.

In some embodiments, the urea derivative comprises a urea metal complex, an n-halo urea, or any combination thereof.

In some embodiments, the binding affinity is via formation of a covalent bond, a coordinative bond or a non-covalent bond between the biocide and the urea functional group. In some embodiments, the binding affinity is via formation of a covalent bond, a coordinative bond, or a non-covalent bond, between the biocide and the carbonyl functional group. In some embodiments, the binding affinity is via formation of a covalent bond, a coordinative bond, or a non-covalent bond, between the biocide and the silane group. As used herein “affinity” refers to the strength of the by which a molecule (e.g., a silane-based monomer or polymer) and its binding partner (e.g., a biocide) interact or bind. Affinity is the sum of the total of interactions between a single binding site of a molecule (e.g., a silane-based monomer or polymer) and its binding partner (e.g., a biocide). Unless indicated otherwise, as used herein, “binding affinity” refers to the intrinsic binding affinity which reflects a 1:1 interaction between members of a binding pair (e.g., silane-based monomer or polymer and biocide). The affinity of a molecule X for its partner Y can generally be represented by the dissociation constant (Kd). Affinity can be measured by common methods known in the art.

In some embodiments, R^{z} is represented by or comprises Formula II:

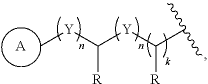

wherein A comprises a urea, a urea metal complex, an n-halo urea, or any combination thereof, each Y independently represents a heteroatom, C, CH, CH₂, —CHR′—, —CR′R′—, or is absent; the heteroatom is selected from the group consisting of O, S, NH, and NR1, or a combination thereof, each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof. In some embodiments, A comprises the urea functional group, the urea derivative or both.

In some embodiments, R² is represented by or comprises Formula IIa:

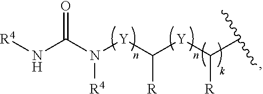

wherein: each Y independently represents a heteroatom, C, CH, CH₂, —CHR′—, —CR′R′—, or is absent; the heteroatom is selected from the group consisting of O, S, NH, and NR1, or a combination thereof, each n and k is a integer ranging from 0 to 10; each R⁴ independently represents hydrogen, halo, or —(CH)ₙSi(OR′)₃, wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; or wherein R⁴ is absent, and the urea group is coordinatively bound to a metal cation.

In some embodiments, R² is represented by or comprises Formula IIb:

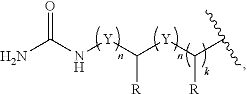

wherein: each Y independently represents a heteroatom, C, CH, CH₂, —CHR′—, —CR′R′—, or is absent; the heteroatom is selected from the group consisting of O, S, NH, and NR1, or a combination thereof; each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, R² is represented by or comprises Formula IIc:

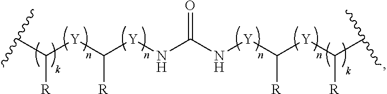

wherein R, Y, n, k, are as described herein.

In some embodiments, the silane-based polymer is represented by or comprises Formula III:

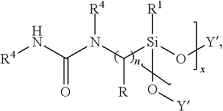

wherein n is an integer ranging from 1 to 5, and R, R¹, R⁴, x and Y′ are as described herein.

In some embodiments, the silane-based polymer is represented by or comprises Formula IIIa:

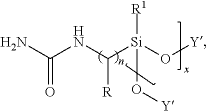

wherein n is an integer ranging from 1 to 5, and R, R¹, x and Y′ are as described herein.

In some embodiments, the silane-based polymer is represented by or comprises Formula IV:

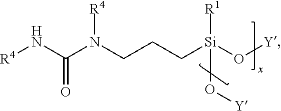

wherein R¹, R⁴, x and Y′ are as described herein.

In some embodiments, the silane-based polymer is represented by or comprises Formula IVa:

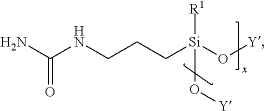

wherein R¹, x and Y′ are as described herein.

In some embodiments, the silane-based polymer is derived from a monomer represented by any one of:

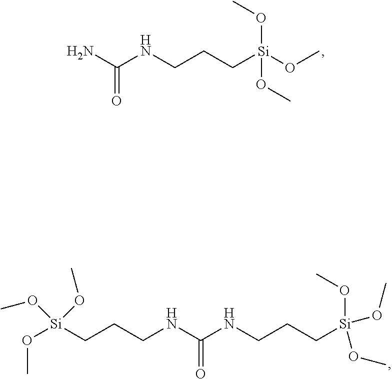

or both.

In some embodiments, the biocide is bound to the silane-based polymer via covalent bond, a coordinative bond, or non-covalent bond. Non-covalent bonds are well-known in the art and include inter alia hydrogen bonds, p-p stacking, Van der Waals interactions, etc. As used herein “coordinative bond” “dative bond”, or “dipolar bond refers to a kind of two-center, two-electron covalent bond in which the two electrons derive from the same atom. Non-limiting example includes the bonding of metal ions to ligands that involve this kind of interaction.

As used herein, the term “biocide” refers to any chemical used to suppress organisms that are harmful to human or animal health, or that cause damage to natural or manufactured materials. Suitable biocides include, but are not limited to, antimicrobials, antibiotics, antimyobacterial, anti-fungals, antivirals, and the like.

In some embodiments, the biocide comprises a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

In some embodiments, Cl is derived from sodium hypochlorite. In some embodiments, Cl is bound to a nitrogen of the urea functional group of the silane-based polymer. In some embodiments, Cl is bound to both nitrogen of the urea functional group of the silane-based polymer. In some embodiments, Cl is bound to a nitrogen of the urea functional group of the silane-based polymer as exemplified in a non-limiting examples in

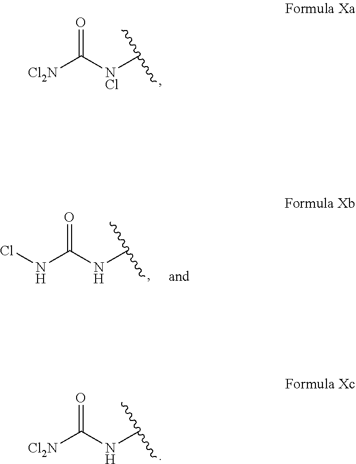

In some embodiments, a coated substrate comprising Cl bound to the silane-based polymer is characterized by increased hydrophobicity compared to a coated substrate devoid of Cl bound to the silane-based polymer. In some embodiments, each of the N—H bond of a urea functional group may be replaced by an N—Cl bond. In some embodiments, the silane-based polymer comprises Cl and urea at a w/w ratio between 1:1 (w/w) and 3:1 (w/w).

In some embodiments, the biocide comprises hydrogen peroxide, or a peroxide source. In some embodiments, the hydrogen peroxide source is selected from liquid hydrogen peroxide sources (i.e. aqueous solutions of hydrogen peroxide) and solid hydrogen peroxide sources (i.e. solid compounds that upon heating or exposure to water release hydrogen peroxide). Examples of solid hydrogen peroxide sources are, e.g., hydrogen peroxide bound in chemical compounds (e.g. a solid compound of hydrogen peroxide bound in polyvinylpyrrolidone (PVP)) and compounds with the potential of developing hydrogen peroxide, e.g. by reaction with water, such as perborates (e.g. sodium perborate), percarbonates (e.g. sodium percarbonate), peroxyphosphates (e.g. sodium peroxyphosphate), persulfates (e.g. potassium persulfate), peroxymonosulfates, peroxydisulfates, urea peroxide, etc. It should be understood that the hydrogen peroxide source referred to herein may consist of one or more of the species of sources, and possibly also a solid source combined with a liquid hydrogen peroxide source. In some embodiments, the biocide comprises a percarboxylic acid (PA), hydrogen peroxide, urea hydrogen peroxide, sodium peroxide, calcium peroxide, silver, silver salt and hydrogen peroxide (HP), sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

In some embodiments, H₂O₂ is bound to the silane-based polymer via hydrogen bond, as exemplified in non-limiting examples in

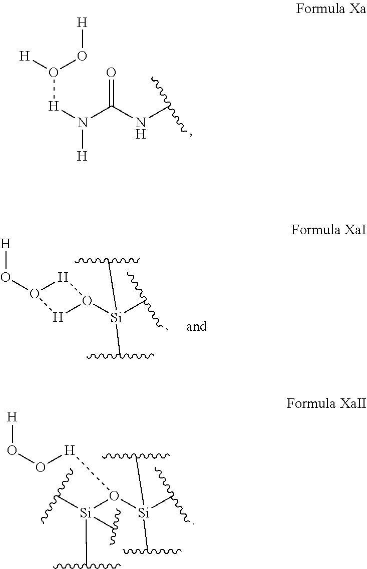

In some embodiments, the essential oil is bound to the silane-based polymer via hydrogen bond, as exemplified in in non-limiting examples in

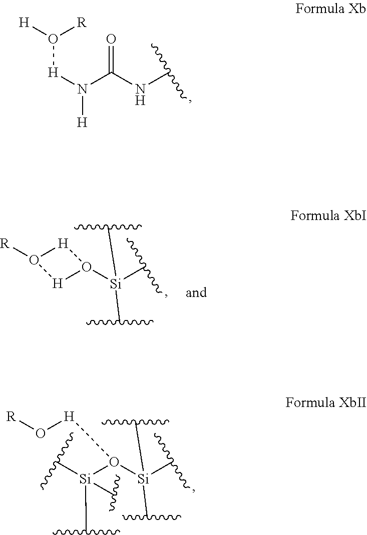

wherein HO—R represents the EO.

As used herein, the term “essential oil (EO)” refers to a product obtained from a natural raw material of plant origin, by steam distillation, by mechanical processes from the epicarp of citrus fruits, or by dry distillation, after separation of the aqueous phase (if any) by physical processes. EOs are well-known and documented in the art and will be apparent to those skilled in the art. Essential oils suitable according to the present invention, are any essential oil characterized by biocidal activity. In some embodiments, the essential oil is selected from the group comprising thymol, arginol, lemonene, cinnamon oil, organum oil, sage oil tea tree oil, carvacrol oil, or any combination thereof.

In some embodiments, the metal ion is coordinated to the silane-based polymer. In some embodiments, the metal ion is bound to the silane-based polymer via Metal-coordination bond, as exemplified in non-limiting examples in

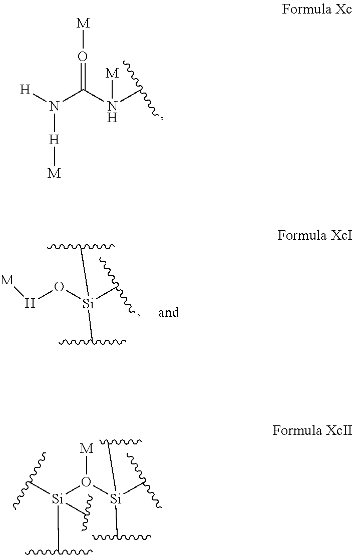

wherein M represents the metal ion.

In some embodiments, the metal ion is any antimicrobial metal ion. In some embodiments, the metal ion is any biocidal metal ion. As used herein “biocidal metal ion” refers to a metal ion characterized by a biocidal activity. In some embodiments, the metal ion is selected from the group comprising Zn²⁺, Cu²⁺ or Ag⁺.

In some embodiments, “biocide” refers to a combination of two or more biocide. In some embodiments, biocide refer to a combination of two biocide. In some embodiments, the coating layer comprises two or more biocide. In some embodiments, the two or more biocide act in synergy.

In some embodiments, the coating layer comprises an antimicrobial effective amount (or loading) of the biocide. In some embodiments, the antimicrobial effective amount (or loading) of the biocide is between 0.1 μmoles/1 cm² and 1000 μmoles/cm², between 0.01 μmoles/1 cm² and 0.1 μmoles/cm², between 0.1 μmoles/1 cm² and 0.5 μmoles/cm², between 0.5 μmoles/1 cm² and 1 μmoles/cm², between 0.1 μmoles/1 cm² and 10 μmoles/cm², between 0.1 μmoles/1 cm² and 20 μmoles/cm², between 0.1 μmoles/1 cm² and 40 μmoles/cm², between 1 μmoles/1 cm² and 10 μmoles/cm², between 1 μmoles/1 cm² and 20 μmoles/cm², between 1 μmoles/1 cm² and 40 μmoles/cm², between 10 μmoles/1 cm² and 40 μmoles/cm², between 40 μmoles/1 cm² and 100 μmoles/cm², between 0.1 μmoles/1 cm² and 100 μmoles/cm², between 0.5 μmoles/1 cm² and 100 μmoles/cm², between 0.5 μmoles/1 cm² and 10 μmoles/cm², between 100 μmoles/1 cm² and 200 μmoles/cm², between 200 μmoles/1 cm² and 500 μmoles/cm², between 500 μmoles/1 cm² and 1000 μmoles/cm², including any range between. Each possibility represents a separate embodiment of the invention. In some embodiments, the biocide comprises any of: a halogen (e.g. chlorine), an antimicrobial metal, and/or a peroxide (such as hydrogen peroxide and/or a source thereof).

In some embodiments, the antimicrobial effective amount refers to a minimum amount (or loading) of the biocide sufficient for exhibiting an antimicrobial activity such as the reduction of the microbial load (or CFU of the microbe) by at least 2 times, at least 10 times, at least 100 times, at least 1000 times, at least 10.000 times, at least 100.000 times, at least 1000.000 times, including any range between. Each possibility represents a separate embodiment of the invention.

In some embodiments, the antimicrobial effective amount comprises any of: (i) between 0.1 μmoles/1 cm² and 100 μmoles/1 cm², or between 0.1 μmoles/1 cm² and 10 μmoles/1 cm², of chlorine; (ii) between 0.1 μmoles/1 cm² and 100 μmoles/1 cm² of H₂O₂, or between 0.1 μmoles/1 cm² and 10 μmoles/1 cm² of H₂O₂, or both (i) and (ii).

In some embodiments, the coating layer comprises between 0.1 μmoles/1 cm² and 100 μmoles/1 cm², between 10 μmoles/1 cm² and 100 μmoles/1 cm², between 15 μmoles/1 cm² and 100 μmoles/1 cm², between 20 μmoles/1 cm² and 100 μmoles/1 cm², between 50 μmoles/1 cm² and 100 μmoles/1 cm², between 70 μmoles/1 cm² and 100 μmoles/1 cm², between 10 μmoles/1 cm² and 90 μmoles/1 cm², between 15 μmoles/1 cm² and 90 μmoles/1 cm², between 20 μmoles/1 cm² and 90 μmoles/1 cm², between 50 μmoles/1 cm² and 90 μmoles/1 cm², between 70 μmoles/1 cm² and 90 μmoles/1 cm², between 10 μmoles/1 cm² and 50 μmoles/1 cm², between 15 μmoles/1 cm² and 50 μmoles/1 cm², or between 20 μmoles/1 cm² and 50 μmoles/1 cm² of chlorine, including any range therebetween. Each possibility represents a separate embodiment of the invention.

In some embodiments, the coating layer comprises between 0.1 μmoles/1 cm² and 100 μmoles/1 cm², between 2 μmoles/14 cm² and 100 μmoles/14 cm², between 3 μmoles/14 cm² and 100 μmoles/14 cm², between 4 μmoles/14 cm² and 100 μmoles/14 cm², between 5 μmoles/14 cm² and 100 μmoles/14 cm², between 2 μmoles/14 cm² and 90 μmoles/14 cm², between 3 μmoles/14 cm² and 90 μmoles/14 cm², between 4 μmoles/14 cm² and 90 μmoles/14 cm², between 5 μmoles/14 cm² and 90 μmoles/14 cm², between 2 μmoles/14 cm² and 50 μmoles/14 cm², between 3 μmoles/14 cm² and 50 μmoles/14 cm², between 4 μmoles/14 cm² and 50 μmoles/14 cm², or between 5 μmoles/14 cm² and 50 μmoles/14 cm² of H₂O₂, including any range therebetween. Each possibility represents a separate embodiment of the invention.

In some embodiments, the coating layer comprises at least two distinct biocide species.

In some embodiments, the coating layer comprises a silane-based polymer and an essential oil at a w/w ratio between 1:50 (w/w) and 1:500 (w/w), between 1:70 (w/w) and 1:500 (w/w), between 1:100 (w/w) and 1:500 (w/w), between 1:250 (w/w) and 1:500 (w/w), between 1:50 (w/w) and 1:350 (w/w), between 1:70 (w/w) and 1:350 (w/w), between 1:100 (w/w) and 1:350 (w/w), between 1:250 (w/w) and 1:350 (w/w), including any range therebetween. Each possibility represents a separate embodiment of the invention. In some embodiments, the silane-based polymer comprises Cl and urea at a w/w ratio between 1:1 (w/w) and 3:1 (w/w). In some embodiments, a coating layer comprising Cl and an essential oil at a w/w ratio as described hereinabove, is characterized by antifungal activity, synergistic antifungal activity and/or antiviral activity. In some embodiments, the coating layer comprises a silane-based polymer and thymol at a w/w ratio between 1:50 (w/w) and 1:500 (w/w), between 1:70 (w/w) and 1:500 (w/w), between 1:100 (w/w) and 1:500 (w/w), between 1:250 (w/w) and 1:500 (w/w), between 1:50 (w/w) and 1:350 (w/w), between 1:70 (w/w) and 1:350 (w/w), between 1:100 (w/w) and 1:350 (w/w), between 1:250 (w/w) and 1:350 (w/w), including any range therebetween. Each possibility represents a separate embodiment of the invention. In some embodiments, the silane-based polymer comprises Cl and urea at a w/w ratio between 1:1 (w/w) and 3:1 (w/w). In some embodiments, a coating layer comprising Cl and thymol at a w/w ratio as described hereinabove, is characterized by antifungal activity, synergistic antifungal activity and/or antiviral activity.

In some embodiments, the coating layer comprises a metal ion and hydrogen peroxide at a weight per weight (w/w) ratio between 1:500 (w/w) and 1:2000 (w/w), between 1:700 (w/w) and 1:2000 (w/w), between 1:900 (w/w) and 1:2000 (w/w), between 1:1000 (w/w) and 1:2000 (w/w), between 1:500 (w/w) and 1:1500 (w/w), between 1:700 (w/w) and 1:1500 (w/w), between 1:900 (w/w) and 1:1500 (w/w), or between 1:1000 (w/w) and 1:1500 (w/w), including any range therebetween. Each possibility represents a separate embodiment of the invention. In some embodiments, the coating layer comprises Ag⁺ and hydrogen peroxide at a weight per weight (w/w) ratio between 1:500 (w/w) and 1:2000 (w/w), between 1:700 (w/w) and 1:2000 (w/w), between 1:900 (w/w) and 1:2000 (w/w), between 1:1000 (w/w) and 1:2000 (w/w), between 1:500 (w/w) and 1:1500 (w/w), between 1:700 (w/w) and 1:1500 (w/w), between 1:900 (w/w) and 1:1500 (w/w), or between 1:1000 (w/w) and 1:1500 (w/w), including any range therebetween. Each possibility represents a separate embodiment of the invention. In some embodiments, a coating layer comprising Ag⁺ and hydrogen peroxide at a weight per weight (w/w) ratio between 1:500 (w/w) and 1:2000 (w/w), is characterized by bactericidal activity, and/or synergistic antibacterial activity.

In some embodiments, the outer surface of the substrate comprises a plurality of hydroxy groups.

According to one aspect, there is provided a composition comprising a partially oxidized substrate comprising a plurality of hydroxy groups and a silane-based polymer as described hereinabove, wherein the silane-based polymer is linked to a portion of (and/or at least one surface of) the substrate, in the form of a first layer. In some embodiments, the silane-based polymer is covalently bound to a portion of (and/or at least one of) the hydroxy groups of the substrate.

The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

The chemistry and morphological properties of the layers, e.g., disposed on top of the substrate, are discussed herein below in the Example section. Moreover, according to one embodiment of the present invention, the layer is homogenized deposited on a surface. In some embodiments, the desired dry thickness of the first layer of the disclosed polymer is characterized by a thickness between 0.1 μm and 50 μm, 0.2 μm and 50 μm, between 0.7 μm and 50 μm, between 0.9 μm and 50 μm, between 1 μm and 50 μm, between 1.2 μm and 50 μm, between 1.5 μm and 50 μm, between 2 μm and 50 μm, between 5 μm and 50 μm, between 0.1 μm and 25 μm, 0.2 μm and 25 μm, between 0.7 μm and 25 μm, between 0.9 μm and 25 μm, between 1 μm and 25 μm, between 1.2 μm and 25 μm, between 1.5 μm and 25 μm, between 2 μm and 25 μm, between 5 μm and 25 μm, 0.5 μm and 10 μm, between 0.7 μm and 10 μm, between 0.9 μm and 10 μm, between 1 μm and 10 μm, between 1.2 μm and 10 μm, between 1.5 μm and 10 μm, between 2 μm and 10 μm, between 5 μm and 10 μm, 0.5 μm and 7 μm, between 0.7 μm and 7 μm, between 0.9 μm and 7 μm, between 1 μm and 7 μm, between 1.2 μm and 7 μm, between 1.5 μm and 7 μm, between 2 μm and 7 μm, between 5 μm and 7 μm, between 0.1 μm and 5 μm, 0.5 μm and 5 μm, between 0.7 μm and 5 μm, between 0.9 μm and 5 μm, between 1 μm and 5 μm, between 1.2 μm and 5 μm, between 1.5 μm and 5 μm, or between 2 μm and 5 μm, including any range therebetween. Each possibility represents a separate embodiment of the invention. As used herein, the term “dry thickness” refers to the thickness of a solid layer (e.g. substantially devoid of solvent). Solid layer refers to a dried coating layer. In some embodiments, solid layer comprises a solvent content of less than 1% (w/w), less than 0.1% (w/w), less than 0.01% (w/w), less than 0.001% (w/w), or less than 0.0001% (w/w), including any range therebetween. Each possibility represents a separate embodiment of the invention.

In some embodiments, the coated substrate comprises at least 2, at least 3, at least 4, at least 5, at least 10, at least 15, at least 20, at least 50, or at least 100 coating layer, including any value therebetween. Each possibility represents a separate embodiment of the invention. In some embodiments, the layers are consecutive layers. In some embodiments, the layers are stacked. In some embodiments, the increase of coating layers increases the thickness of the final coating. It should be understood that a substrate comprising e.g. 2 coating layers is characterized by a dry thickness of 2 individual layers (the double of the dry thickness of a first coating layer as described hereinabove). In some embodiments, the coating layer (e.g. a multi-layer coating) remains its stability and/or optic properties at a thickness up to 100 μm, up to 250 μm, up to 500 μm, up to 700 μm, up to 500 μm, up to 1000 μm, up to 2500 μm, or up to up to 5000 μm, including any value therebetween. Each possibility represents a separate embodiment of the invention.

In some embodiments, the coating layer is a mesoporous coating layer. In some embodiments, the mesoporous coating layer refers to mesoporous SiO₂-coating. In some embodiments, the mesoporous SiO₂-coating is characterized by a pore size between 2 nm and 50 nm, between 4 nm and 50 nm, between 5 nm and 50 nm, between 10 nm and 50 nm, between 12 nm and 50 nm, between 2 nm and 40 nm, between 4 nm and 40 nm, between 5 nm and 40 nm, between 10 nm and 40 nm, between 12 nm and 40 nm, between 2 nm and 25 nm, between 4 nm and 25 nm, between 5 nm and 25 nm, between 10 nm and 25 nm, or between 12 nm and 25 nm, including any range therebetween. Each possibility represents a separate embodiment of the invention. As used herein, the terms “pore” and “porous” refer to an opening or depression in the surface of a mesoporous SiO₂-coating or coating layer.

In some embodiments, the mesoporous SiO₂-coating is a porous silica-based matrix comprising amorphous polysiloxane. In some embodiments, the matrix is in a form of a mesh comprising interconnected (via covalent Si—O bonds) polysiloxane. In some embodiments, the polysiloxane is characterized by a repeating unit of

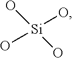

also assigned as SiO₂.

In some embodiments, the matrix further comprises an additional polysiloxane. In some embodiments, the additional polysiloxane is physically and/or covalently bound to the silica chains. In some embodiments, the matrix comprises a plurality of chemically distinct polysiloxane species bound via a covalent and/or a non-covalent bond.

In some embodiments, the additional polysiloxane is a copolymer. In some embodiments, the additional polysiloxane is a graft-copolymer or a block-copolymer. In some embodiments, the additional polysiloxane is or comprises a polysiloxane backbone modified with a hydrophobic polymer, such as polyalkoxylate (e.g. PEG, optionally comprising a terminal hydroxy and/or amino group). In some embodiments, the additional polysiloxane is or comprises a PEG-ylated silica or a PEG-ylated polysiloxane. In some embodiments, the additional polysiloxane is or comprises a PEG-ylated polysiloxane graft co-polymer.

In some embodiments, the porous matrix further comprises a surfactant, and optionally a stabilizer incorporated (or physically bound) on top and/or within the matrix, as described herein. In some embodiments, the surfactant is incorporated within the matrix, and is bound to the polysiloxane. In some embodiments, the surfactant stabilizes the micelles within the coating composition and induces pore formation. In some embodiments, the surfactant stabilizes the porous structure of the mesoporous silica coating.

In some embodiments, the stabilizer provides or enhances heat sealing capabilities of the mesoporous silica coating.

The term “silica” and the term “SiO₂” are used herein interchangeably.

In some embodiments, the coating layer consists of the polymer of the invention and the biocide, as the functional ingredients. In some embodiments, the coating layer consists of the polymer of the invention and optionally of the biocide as the functional ingredients. In some embodiments, the coating layer consists essentially of the polymer of the invention and the biocide. In some embodiments, at least 80%, at least 82%, at least 85%, at least 90%, at least 95%, at least 98%, or at least 99% of the coating layer consist of the polymer of the invention and the biocide, including any value therebetween. Each possibility represents a separate embodiment of the invention. As used herein, the term “consisting essentially of” means that the composition, coating or article may include additional ingredients, but only if the additional ingredients, do not materially alter the basic and novel characteristics of the claimed composition, coating or article.

In some embodiments, the coated substrate is substantially stable (e.g., the coated substrate substantially maintains its structural and/or functional properties, such as stability of the coating layer, absence of disintegration or erosion of the coating layer) for at least one week (w), at least 2 w, least one month (m), at least 2 m, at least 6 m, at least 12 m, at least 2 years (y), at least 3 y, at least 10 y, including any range therebetween, wherein substantially is as described hereinbelow. Each possibility represents a separate embodiment of the invention.

In some embodiments, the coated substrate is substantially stable upon exposure to (i) organic materials, (ii) microbial loading cycles or a combination of (i) and (ii). In some embodiments, the coated substrate substantially maintains its biocidal activity upon exposure to (i) organic materials, (ii) microbial loading cycles or a combination of (i) and (ii). In some embodiments, the term “stable” refers to the ability of the coating layer to substantially maintain its structural, physical, biological and/or chemical properties.

In some embodiments, a coated substrate comprising a coating layer comprising a polymer as described herein and a biocide is characterized by an improved biocidal activity, as compared to a reference biocide. In some embodiments, a coated substrate comprising a coating layer comprising a polymer as described herein and a biocide is characterized by an improved stability, as compared to a reference biocide. By “improved stability” it is meant to refer to having a more desirable shelf live, or chemical property. In some embodiments, improved stability refers to improved heat resistance, and/or improved moisture resistance. In some embodiments, the composition is characterized by a stability (e.g., shelf life) of at least 2 months, at least 3 months, at least 4 months, at least 5 months, at least 6 months, at least 1 year, at least 2 years, at least 5 years, or at least 10 years including any value therebetween. Each possibility represents a separate embodiment of the invention. In some embodiments, the shelf live is extended by at least 1 day, at least 5 days, at least 10 days, at least 20 days, at least 50 days, at least 2 months, at least 3 months, at least 5 months, or at least 1 year, including any value therebetween. Each possibility represents a separate embodiment of the invention.

In some embodiments, the substrate is selected from the group consisting of: a polymeric substrate, a metallic substrate, a paper substrate a glass substrate, and any combination thereof. In some embodiments, the polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof. In some embodiments, the metallic substrate comprises a metal oxide selected from the group consisting of iron oxide, titanium oxide, titania, alumina, silica, hafnium oxide, zinc oxide, copper oxide, and aluminum oxide. In some embodiments, the glass substrate is selected from a borosilicate-based glass substrate, silicon-based glass substrate, ceramic-based glass substrate, silica/quartz-based glass substrate, aluminosilicate-based glass substrate, or any combination thereof.

In some embodiments, the metallic substrate comprises a metal (e.g. a metal in an elemental state). Non-limiting examples of metals include but are not limited to: Fe, Ti, Al, Au, Pt, Ru, Rh, Ag, Ir, Pd, Ni, Co, Cu, Zn, Mn, V, Cr, Zr, Mo, and W including any mixture or an alloy thereof.

In some embodiments, the coated substrate is characterized by a water contact angle on the surface of the coating layer between 400 and 100°, between 500 and 100°, between 600 and 100°, between 710 and 100°, between 720 and 100°, between 750 and 100°, between 780 and 100°, between 800 and 100°, between 710 and 98°, between 720 and 98°, between 750 and 98°, between 780 and 98°, between 800 and 98°, between 710 and 90°, between 720 and 90°, between 750 and 90°, between 780 and 90°, or between 800 and 90°, including any range therebetween. Each possibility represents a separate embodiment of the invention.

In some embodiments, the coating layer is an antimicrobial coating, synergistic antimicrobial coating, antibiofilm coating, bacteriostatic coating, fungicidal coating, fungistatic coating, pesticide coating, antiviral coating, or any combination thereof.

In some embodiments, the coating layer is configured to release an antimicrobial effective amount of the biocide to an ambient, and wherein the coating layer is any of: an antimicrobial coating, synergistic antimicrobial coating, antibiofilm coating, bacteriostatic coating, fungicidal coating, fungistatic coating, pesticide coating, antiviral coating, or any combination thereof. As used herein, the term “ambient” refers to an immediate surroundings. In some embodiments, the ambient refers to the surrounding atmosphere. In some embodiments, the ambient refers to a liquid or a solution. In some embodiments, the ambient refers to a plant or a food product.

In some embodiments, the coated substrate further comprises an additional coating layer. In some embodiments, the additional coating layer provides a biocide release barrier. In some embodiments, the additional coating layer is gas impermeable.

In some embodiments, an outer surface of the coating layer is further bound to an additional coating layer being substantially gas impermeable. In some embodiments, the additional coating layer is removable. In some embodiments, the additional coating layer is biodegradable. In some embodiments, the additional coating layer (gas impermeable coating layer) protects/covers at least a part of the surface of the coating layer of the coated substrate. In some embodiments, the gas impermeable coating layer forms a contiguous layer covering essentially all the surface of the coating layer of the coated substrate to the ambient.

In some embodiments, the additional coating layer (gas impermeable coating layer) protects and/or retards the release of the biocide from the coating layer of the coated substrate to the ambient.

In some embodiments, the additional coating layer is a gas impermeable coating layer. As used herein “gas impermeable coating” refers to a coating layer capable of preventing the release or decreasing the rate of release of a gas. As used herein “gas” refers to any gas including water vapor. In some embodiments, the gas impermeable coating layer is a gas and/or water barrier, for reduction or prevention of gas and/or water diffusion from the coated substrate.

In some embodiments, the additional coating layer is characterized by a biocide transmission rate of at most 5, at most 2, at most 1, at most 0.5, at most 0.1 [g/m²/24 h], including any range between.

In some embodiments, the additional coating layer comprises a polymer, a protein, a wax, a resin, a metal, and any derivative or combination thereof. In some embodiments, the additional coating layer further comprises a surfactant as described herein.

As used herein, “wax” refers to a low melting organic mixture, or a compound of high molecular weight that is a solid at lower temperatures and a liquid at higher temperatures, and when in solid form can form a barrier (e.g., to water). Examples of waxes include animal waxes, vegetable waxes, mineral waxes, petroleum waxes, and synthetic waxes. In some embodiments, the additional coating layer comprises paraffin wax. In some embodiments, the additional coating layer comprises paraffin wax and a surfactant.

In some embodiments, the additional coating layer comprises a biopolymer, such as polypeptides, proteins, polysaccharides and fatty acids (and esters thereof), including fibrin, fibrinogen, collagen, elastin, chitosan, gelatin, starch, glycosaminoglycans such as hyaluronic acid; copolymers of the above, or any combination thereof.

In some embodiments, the additional coating layer comprises a polymer selected from a polyolefin, a polyol, or any combination or a co-polymer thereof. In some embodiments, the polyolefin comprises a polyethylene, a polypropylene, polymethylpentene (PMP), polybutene-1 (PB-1); ethylene-octene copolymer, stereo-block polypropylene, propylene-butane copolymer, or any combination thereof. In some embodiments, the polyol comprises polyvinyl alcohol (PVA), ethylene vinyl alcohol copolymer (EVOH), or both. In some embodiments, polyethylene comprises low-density polyethylene (LDPE), linear low-density polyethylene (LLDPE), very-low-density polyethylene (VLDPE), ultra-low-density polyethylene (ULDPE), medium-density polyethylene (MDPE), high-density polyethylene (HDPE) or any combination thereof. In some embodiments, the additional coating layer comprises polyethylene, polypropylene, polyvinyl fluoride, polyvinylidene polyfluoride, ethylene tetrafluoride, propylene hexafluoride copolymer, saponified ethylene-vinyl acetate copolymers, or any combination thereof.

### The Process

According to an aspect of some embodiments of the present invention there is provided a process for coating a substrate, comprising the steps of: (a) providing an at least partially oxidized substrate comprising a plurality of hydroxy groups, and (b) contacting the substrate with the silane-based monomer described hereinabove, under conditions suitable for the silane-based monomer to polymerize and covalently bound to the substrate, thereby forming a coated substrate. In some embodiments, the coated substrate is a coated substrate as described hereinabove.

According to an aspect of some embodiments of the present invention there is provided a process for coating a substrate, comprising the steps of: (a) providing at least partially oxidized substrate comprising a plurality of hydroxy groups; and (b) contacting the substrate with a composition comprising: (i) a silane-based monomer, wherein the silane-based monomer is represented by or comprises Formula V:

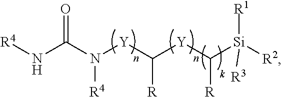

wherein: each of R¹, R², R³ independently represents hydrogen, or is selected from the group comprising optionally substituted C₁-C₆ alkyl, —O(C₁-C₆ alkyl), —OH, or a combination thereof, wherein at least one R¹, R² or R3 represents the substituent; each R⁴ independently represents hydrogen, halo, or —(CH)ₙSi(OR′)₃, or R⁴ is absent and the urea group is coordinatively bound to a metal ion (e.g. an antibacterial metal cation); wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; each Y independently represents a heteroatom, C, CH, CH₂, —CHR1-, —CR1R1-, or is absent; the heteroatom is selected from the group consisting of O, S, NH, and NR1, or a combination thereof, each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and (ii) a solvent, a surfactant or both, under conditions suitable for the silane-based monomer to polymerize and covalently bound to the substrate, thereby forming a coating layer on the substrate.

In some embodiments, the process further comprises a step of contacting the coating layer with a biocide a biocide comprising a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof. In some embodiments, the process further comprises a step of contacting the composition comprising the silane-based monomer with a biocide a biocide comprising a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

In some embodiments, the coated substrate is the coated substrate described hereinabove.

In some embodiments, the process further comprises a step (c) of washing the substrate to remove non-bound silane-based monomer.

In some embodiments, contacting is selected from the group comprising: dipping, spraying, spreading, casting, rolling, adhering, printing, curing, sonication, or any combination thereof. In some embodiments, the coating can be easily applied in the substrate with the use of a brush, roller, spray, or dipping. In some embodiments, the coating is applied to the substrate by a method selected from the group comprising: spin coating, spray coating, spray and spin coating, curtain coating, flow coating, dip coating, injection molding, casting, roll coating, wire coating, thermal spraying, high velocity oxygen fuel coating, centrifugation coating, spin coating, vapor phase deposition, chemical vapor deposition, physical vapor deposition and any of the methods used in preparing coating layers.

Generally, the application method selected will depend upon, among other things, chemical properties of materials composing the coating, the thickness of the desired coating, the geometry of the substrate to which the coating is applied, and the viscosity of the coating. Other coating methods are well known in the art and some of them may be applied to the present application.

In some embodiments, the method further comprises a step of drying the coated substrate. In some embodiments, drying is performed by convection drying, such as by applying a hot gas stream to a coated substrate. In some embodiments, drying is performed by cold drying, such as by applying a de-humidified gas stream to a coated substrate.

In some embodiments, the method further comprises vacuum drying of the coated substrate.

In some embodiments, the silane-based monomer is represented by or comprises Formula VI:

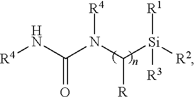

wherein R, R¹, R², R³, R⁴, and n are as described herein.

In some embodiments, the silane-based monomer is represented by or comprises any one of:

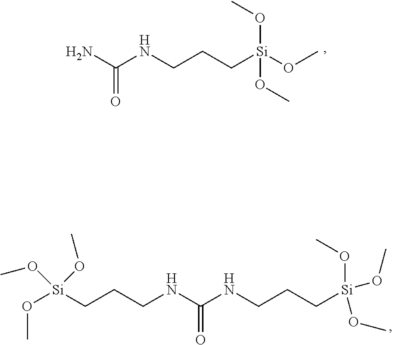

or both.

In some embodiments, the coating layer is characterized by a wet thickness between 1 μm and 2000 μm, between 5 μm and 2000 μm, between 10 μm and 2000 μm, between 50 μm and 2000 μm, between 100 μm and 2000 μm, between 250 μm and 2000 μm, between 500 μm and 2000 μm, between 1000 μm and 2000 μm, between 1 μm and 1200 μm, between 5 μm and 1200 μm, between 10 μm and 1200 μm, between 50 μm and 1200 μm, between 100 μm and 1200 μm, between 250 μm and 1200 μm, or between 500 μm and 1200 μm, including any range therebetween. Each possibility represents a separate embodiment of the invention.

As used herein, the term “wet thickness” refers to the thickness of a layer formed as measured after adding a liquid composition to the substrate, as described herein.

In some embodiments, the solvent is a protic solvent. In some embodiments, the solvent is a protic solvent selected from the group consisting of: water, ethanol, methyl ethyl ketone, isopropanol, methanol, butanol and any combination thereof.

In some embodiments, the composition comprises water and ethanol at a volume per volume (v/v) ratio between 1:2 (v/v) and 1:20 (v/v), between 1:3 (v/v) and 1:20 (v/v), between 1:5 (v/v) and 1:20 (v/v), between 1:8 (v/v) and 1:20 (v/v), between 1:2 (v/v) and 1:18 (v/v), between 1:3 (v/v) and 1:18 (v/v), between 1:5 (v/v) and 1:18 (v/v), between 1:8 (v/v) and 1:18 (v/v), between 1:2 (v/v) and 1:15 (v/v), between 1:3 (v/v) and 1:15 (v/v), between 1:5 (v/v) and 1:15 (v/v), or between 1:8 (v/v) and 1:15 (v/v), including any range therebetween. Each possibility represents a separate embodiment of the invention.

In some embodiments, the composition comprises between 0.01% (w/w) and 0.2% (w/w), between 0.05% (w/w) and 0.2% (w/w), between 0.09% (w/w) and 0.2% (w/w), between 0.1% (w/w) and 0.2% (w/w), 0.01% (w/w) and 0.1% (w/w), between 0.05% (w/w) and 0.1% (w/w), or between 0.09% (w/w) and 0.1% (w/w) of a surfactant, including any range therebetween. Each possibility represents a separate embodiment of the invention. In some embodiments, the surfactant is a cationic surfactant. In some embodiments, the surfactant is selected from the group consisting of: cetyltrimethylammonium bromide (CTAB), cetyltrimethylammonium chloride (CTACI), tetradecyltrimethylammonium bromide (TTAB), tetradecyltrimethyl ammonium chloride (TTACl), dodecyltrimethylammonium bromide (DTAB), dodecyl trimethylammonium chloride (DTACl), dodecylethyidimethylammonium bromide (DEDTAB), decyltrimethylammonium bromide (D10TAB), dodecyl triphenylphosphonium bromide (DTPB), polyvinylpyrrolidone (PVP), and any salt or any combination thereof.

In some embodiments, the composition comprises a base. In some embodiments, the composition comprises between 5 mM and 40 mM, between 7 mM and 40 mM, between 10 mM and 40 mM, between 15 mM and 40 mM, between 20 mM and 40 mM, between 5 mM and 15 mM, between 7 mM and 15 mM, or between 10 mM and 15 mM, of a base, including any range therebetween. Each possibility represents a separate embodiment of the invention. In some embodiments, the base is selected from NH₄OH, KOH, NaOH, or a combination thereof.

In some embodiments, the composition comprises between 0.1% (w/v) and 20% (w/v), between 0.2% (w/v) and 20% (w/v), between 0.5% (w/v) and 20% (w/v), between 0.9% (w/v) and 20% (w/v), between 1% (w/v) and 20% (w/v), between 5% (w/v) and 20% (w/v), between 0.1% (w/v) and 15% (w/v), between 0.2% (w/v) and 15% (w/v), between 0.5% (w/v) and 15% (w/v), between 0.9% (w/v) and 15% (w/v), between 1% (w/v) and 15% (w/v), or between 5% (w/v) and 15% (w/v), of the silane-based monomer, including any range therebetween. Each possibility represents a separate embodiment of the invention.

In some embodiments, the method further comprises a step of thermal curing the coated substrate at temperature between 40° C. and 200° C., between 50° C. and 200° C., between 60° C. and 200° C., between 70° C. and 200° C., between 40° C. and 100° C., between 50° C. and 100° C., between 60° C. and 100° C., between 70° C. and 100° C., between 40° C. and 85° C., between 50° C. and 85° C., between 60° C. and 85° C., or between 70° C. and 85° C., including any range therebetween. Each possibility represents a separate embodiment of the invention.

In some embodiments, the substrate is an at least partially oxidized substrate. In some embodiments, prior to the coating process, the surface of the substrate is treated by methods known in the art, such as, and without being limited thereto, plasma treatment, UV-ozone treatment, or corona discharge.

In some embodiments, the substrate is selected from the group consisting of: a polymeric substrate, a metallic substrate, a paper substrate, a glass substrate, and any combination thereof.

As used herein the term “coating” and any grammatical derivative thereof, is defined as a coating that (i) is positioned above a substrate, (ii-a) it is in contact with the substrate, or (ii-b) is not necessarily in contact with the substrate, that is to say one or more intermediate coatings may be arranged between the substrate and the coating in question, and (iii) does not necessarily completely cover the substrate. In some embodiments, the coating can be applied as single coating layer or as a plurality of coating layers.

According to an aspect of some embodiments of the present invention there is provided a process for receiving a coated substrate, comprising a substrate and the silane-based polymer linked to a portion of at least one surface of the substrate, and a biocide, wherein the wherein the biocide is bound to the silane-based polymer via covalent bond or non-covalent bond.

As used herein, the term “silane” refers to monomeric silicon compounds with four substituents, or groups, attached to the silicon atom. These groups can be the same or different and nonreactive or reactive, with the reactivity being inorganic or organic.

By “silane derivative” or “silane coupling agent” is meant a silane having at least one chemical moiety that does participate in polymerization of the silane. This chemical moiety may have a reactive functional group to attach other chemical species to the silane monomer or polymer, e.g., organic molecules.

As used herein, “crosslinked” and/or “crosslinking”, and any grammatical derivative thereof refers generally to a chemical process or the corresponding product thereof in which two chains of polymeric molecules are attached by bridges (crosslinker) composed of an element, a group or a compound, which join certain carbon atoms of the chains by primary chemical.

In some embodiments, the terms “coating layer” and “coating” are used herein interchangeably.

In some embodiments, the substrate is at least partially hydrophobic substrate. In some embodiments, the substrate is a hydrophobic substrate. In some embodiments, the substrate is at least partially hydrophilic. In some embodiments, the substrate is a hydrophilic substrate. In some embodiments, the substrate is at least partially oxidized.

Substrate usable according to some embodiments of the present invention can have, for example, organic or inorganic surfaces, including, but not limited to, glass surfaces; porcelain surfaces; ceramic surfaces; organosilicon surfaces, metallic surfaces (e.g., stainless steel); metal oxides such as aluminum oxide, polymeric surfaces such as, for example, plastic surfaces, paper, wood, fabric in a woven, knitted or non-woven form, mineral (rock or glass), surfaces, wool, silk, cotton, hemp, leather, fur, feather, skin, hide, pelt or pelage surfaces, plastic surfaces and surfaces comprising or made of polymers, nylons, inorganic polymers, or can comprise or be made of any of the foregoing substances, or any mixture thereof. The substrate may be any number of substrates, porous, and non-porous substrates. By non-porous it is meant that a substrate does not have pores sufficient to significantly increase the bonding of the coating to the unprimed substrate. Non-porous substrates are selected from but are not limited to polymers of polycarbonate, polyesters, nylons, and metallic foils such as aluminum foil, with nylons and metallic foils.

In some embodiments, the substrate comprises a glass substrate. Non-limiting examples of glass substrates according to the present invention comprise: borosilicate-based glass substrate, ceramic-based glass substrate, silica/quartz-based glass substrate, aluminosilicate-based glass substrate, or any combination thereof.

In some embodiments, the substrate is a metal substrate. In some embodiments, the metal substrate is further coated with a paint and/or lacquer.

Substrate usable according to some embodiments of the present invention can therefore be hard (rigid) or soft, solid, semi-solid, or liquid substrates, and may take a form of a foam, a solution, an emulsion, a lotion, a gel, a cream or any mixture thereof.

Substrates of widely different chemical nature can be successfully utilized for incorporating the disclosed composition and coating layers, as described herein. By “successfully utilized” it is meant that (i) the disclosed composition and coating layers, successfully form a uniform and homogenously coating on the substrate's surface; and (ii) the resulting coating imparts long-lasting desired properties to the substrate's surface. In some embodiments, the substrate is further coated with a lacquer, a varnish or a paint.

In some embodiments, the disclosed composition and coating layer form a layer thereof in/on a surface the substrate. In some embodiments, the coating layer represent a surface coverage referred to as “layer” e.g., 100%. In some embodiments, the coating layer represents about 90%, about 80%, about 70%, about 60%, about 50%, about 40%, of surface coverage, including any value therebetween. In some embodiments, the substrate further comprises a plurality of coating layers.

In some embodiments, the coating layer is homogenized deposited on a surface.

In some embodiments, the composition or the coating layer in a solution comprising solvent as described herein. In some embodiments, the solution is devoid of a curing agent, a surfactant, or a stabilizer.

In some embodiments, the resulting coated substrates are air-dried. In some embodiments, the coating process further comprises a step of evaporating the solvent(s) mixture or coating (e.g., the mixture or coating deposited on the substrate). The step of evaporating the solvent(s) may be performed at e.g., room temperature (i.e. 15° C. to 30° C.) or at elevated temperature (i.e. up to 100° C.).

According to an aspect of some embodiments of the present invention there is provided a coated substrate, obtained by the process described hereinabove. In some embodiments, the coated substrate comprises a substrate, a silane-based polymer, and a biocide.

In some embodiments, there is provided a coated substrate, obtained by the process described hereinabove, wherein the coated substrate comprises a substrate, a silane-based polymer, and a biocide, wherein: i) the silane-based polymer is covalently bound to at least a portion of the substrate, forming a coating layer; and ii) the silane-based polymer is represented by or comprises Formula I:

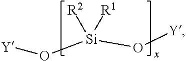

wherein: x represents an integer between 2 and 10.000; each Y′ independently represents H or a covalent bond to the substrate; R² comprises a terminal urea functional group, or a derivative thereof; R¹ represents hydrogen, or is selected from the group comprising

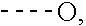

optionally substituted C₁-C₆ alkyl, —O(C₁-C₆ alkyl), —OH, or a combination thereof; [symbol] represents a covalent bond to i) the substrate, or ii) to an [symbol] adjacent monomer; and wherein the silane-based polymer comprises at least one covalent bond to the substrate.

### Articles

According to an aspect of some embodiments of the present invention there is provided an article comprising the coated substrate described herein or the composition described herein.

In some embodiments, the coated substrate described herein is or forms a part of an article. Hence according to an aspect of some embodiments of the present invention there is provided an article comprising a coated substrate incorporating in and/or on at least a portion thereof a composition, as described in any one of the respective embodiments herein.

In some embodiments, the article is selected from the group consisting of: transparent plastic surfaces, lenses, a package (e.g., food package, medical device package, agricultural package, and biological sample package), microelectronic device, a microelectromechanic device, a photovoltaic device, a microfluidic device, a medical device, a textile, a construction element (e.g., paints, walls, windows, handles). In some embodiments, the article according to the invention may be any optical article, such as a screen, a glazing for the automotive industry or the building industry, a mirror, an optical lens, or an ophthalmic lens. Exemplary articles include, but are not limited to, medical devices, organic waste processing device, fluidic device, an agricultural device, a package (e.g., a food packaging), a sealing article, a fuel container, a water and cooling system device and a construction element.

### Modified Metal Oxide Particles

According to an aspect of some embodiments of the present invention there is provided a modified metal oxide particle. In some embodiments, the modified metal oxide particle comprises a core and a shell, wherein the shell is covalently bound to at least a portion of the core; and the shell comprises a silane-based polymer comprising a urea functional group, or a derivative thereof. In some embodiments, the particle comprises a biocide bound to the urea functional group of the silane-based polymer. In some embodiments, the modified metal oxide particle is a silane-based particle as described herein.

According to an aspect of some embodiments of the present invention there is provided a silane-based particle. In some embodiments, the silane-based particle comprises a core and a shell, wherein the shell is covalently bound to at least a portion of the core; and the shell comprises a silane-based polymer comprising a urea functional group, or a derivative thereof. In some embodiments, the particle comprises a biocide bound to the urea functional group of the silane-based polymer.

In some embodiments, the modified metal oxide particle comprises a core and a shell, wherein: i. the particle is characterized by an average diameter between 10 nm and 400 nm; ii. the shell is covalently bound to at least a portion of the core; and iii. the shell comprises a silane-based polymer represented by Formula I:

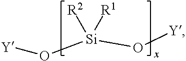

wherein: x represents an integer between 2 and 10.000; each Y′ independently represents H or a covalent bond to the core; R² comprises a terminal urea functional group, or a derivative thereof, R¹ represents hydrogen, or is selected from the group comprising

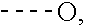

optionally substituted C₁-C₆ alkyl, —O(C₁-C₆ alkyl), —OH, or a combination thereof; [symbol] represents a covalent bond to i) the core, or ii) to an adjacent monomer; and wherein the silane-based polymer comprises at least one covalent bond to the core.

In some embodiments, the biocide is bound to the silane-based polymer via covalent bond or non-covalent bond, as described hereinabove. In some embodiments, the biocide comprises a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

According to an aspect of some embodiments of the present invention there is provided a composition comprising a silane-based particle comprising a core and a shell, wherein: i. particle is characterized by an average diameter between 10 nm and 400 nm; ii. the shell is covalently bound to at least a portion of the core; and iii. The shell comprises a silane-based polymer represented by Formula I:

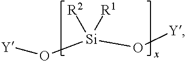

wherein: x represents an integer between 2 and 10.000; each Y′ independently represents H or a covalent bond to the core; R² comprises a terminal urea functional group, or a derivative thereof, R¹ represents hydrogen, or is selected from the group comprising

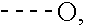

optionally substituted C₁-C₆ alkyl, —O(C₁-C₆ alkyl), —OH, or a combination thereof; [symbol] represents a covalent bond to i) the core, or ii) to an adjacent [symbol] monomer; and wherein the silane-based polymer comprises at least one covalent bond to the core.

In some embodiments, the particle is characterized by an average diameter between 10 nm and 400 nm, between 10 nm and 100 um, between 15 nm and 400 nm, between 20 nm and 400 nm, between 50 nm and 400 nm, between 100 nm and 400 nm, between 200 nm and 400 nm, between 400 nm and 800 nm, between 800 nm and 1 um, between 1 um and 10 um, between 10 and 50 um, between 50 and 100 um, between 10 nm and 300 nm, between 15 nm and 300 nm, between 20 nm and 300 nm, between 50 nm and 300 nm, between 100 nm and 300 nm, between 200 nm and 300 nm, between 10 nm and 90 nm, between 15 nm and 90 nm, between 20 nm and 90 nm, or between 50 nm and 90 nm, including any range therebetween. Each possibility represents a separate embodiment of the invention.

In some embodiments, the core of the particle comprises SiO₂-based matrix comprising amorphous polysiloxane. In some embodiments, the matrix is in a form of a mesh comprising interconnected (via covalent Si—O bonds) polysiloxane. In some embodiments, the polysiloxane is characterized by a repeating unit of

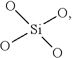

also assigned as SiO₂.

In some embodiments, the matrix further comprises an additional polysiloxane. In some embodiments, the additional polysiloxane is physically and/or covalently bound to the silica chains. In some embodiments, the matrix comprises a plurality of chemically distinct polysiloxane species bound via a covalent and/or a non-covalent bond.

In some embodiments, the particle described herein is characterized by a spherical shape. In some embodiments, a particle as described herein is a nanoparticle. In some embodiments, a particle as described herein is a microparticle.

Herein throughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s). The term “microparticle” as used herein refers to a particle featuring a size of at least one dimension thereof (e.g., diameter, length) that ranges from about 1 micrometer to 100 micrometers.

In some embodiments, the size of the particles described herein represents an average or median size of a plurality of nanoparticles and/or microparticles. In some embodiments, a plurality of the particles has a uniform size. By “uniform” or “homogenous” it is meant to refer to size distribution that varies within a range of less than e.g., ±60%, ±50%, ±40%, ±30%, ±20%, or +10%, including any value therebetween. As used herein the terms “average” or “median” size refer to diameter of the polymeric particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS). As exemplified in the Example section that follows, the dry diameter of the particles, as prepared according to some embodiments of the invention, may be evaluated using transmission electron microscopy (TEM) or scanning electron microscopy (SEM) imaging. The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

In some embodiments, R² is represented by or comprises Formula II:

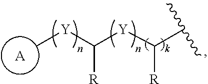

wherein: A comprises a urea, a urea metal complex, an n-halo urea, or any combination thereof; each Y independently represents a heteroatom, C, CH, CH₂, —CHR1-, —CR1R1-, or is absent; the heteroatom is selected from the group consisting of O, S, NH, and NR1, or a combination thereof, each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof. In some embodiments, A comprises the urea functional group, the urea derivative or both.

In some embodiments, R² is represented by or comprises Formula IIa:

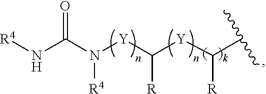

wherein: each Y independently represents a heteroatom, C, CH, CH₂, —CHR′—, —CR′R′—, or is absent; the heteroatom is selected from the group consisting of O, S, NH, and NR1, or a combination thereof, each n and k is a integer ranging from 0 to 10; each R⁴ independently represents hydrogen, halo, or —(CH)ₙSi(OR′)₃, or R⁴ is absent, and the urea group is bound to a metal (e.g. an antibacterial metal ion); wherein R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, R² is represented by or comprises Formula IIb:

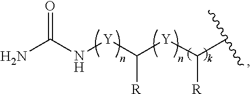

wherein: each Y independently represents a heteroatom, C, CH, CH₂, —CHR′—, —CR′R′—, or is absent; the heteroatom is selected from the group consisting of O, S, NH, and NR1, or a combination thereof; each n and k is a integer ranging from 0 to 10; and each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof.

In some embodiments, R² is represented by or comprises Formula IIc:

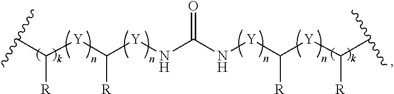

wherein R, Y, n, k, are as described herein.

In some embodiments, the silane-based polymer is represented by or comprises Formula III:

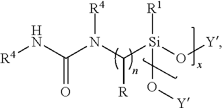

wherein n is an integer ranging from 1 to 5, and R, R¹, R⁴, x and Y′ are as described herein.

In some embodiments, the silane-based polymer is represented by or comprises Formula IIIa:

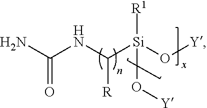

wherein n is an integer ranging from 1 to 5, and R, R¹, Y′ and x are as described herein.

In some embodiments, the silane-based polymer is represented by or comprises Formula IV:

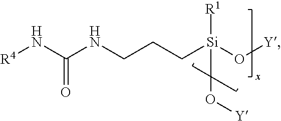

wherein R¹, R⁴, x and Y′ are as described herein.

In some embodiments, the silane-based polymer is represented by or comprises Formula IVa:

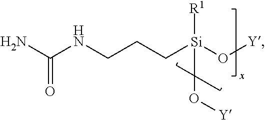

wherein R¹, x and Y′ are as described herein.

In some embodiments, the silane-based polymer is derived from a monomer represented by any one of:

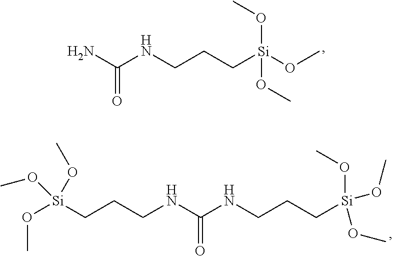

or both.

In some embodiments, the composition further comprises a biocide.

In some embodiments, the biocide is bound to the silane-based polymer via covalent bond or non-covalent bond. Non-covalent bonds are well-known in the art and include inter alia hydrogen bonds, p-p stacking, Van der Waals interactions, etc.

In some embodiments, the biocide comprises chlorine (Cl), hydrogen peroxide (H₂O₂), essential oil, metal ion, or any combination thereof.

In some embodiments, Cl is derived from sodium hypochlorite. In some embodiments, Cl is bound to a nitrogen of the urea functional group of the silane-based polymer. In some embodiments, Cl is bound to both nitrogen of the urea functional group of the silane-based polymer. In some embodiments, Cl is bound to a nitrogen of the urea functional group of the silane-based polymer as exemplified in a non-limiting examples in

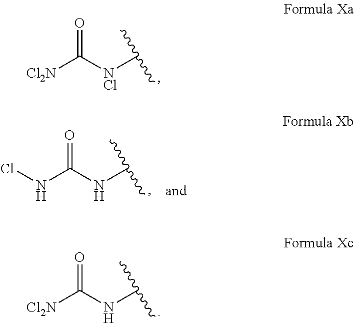

In some embodiments, a coated substrate comprising Cl bound to the silane-based polymer is characterized by increased hydrophobicity compared to a coated substrate devoid of Cl bound to the silane-based polymer. In some embodiments, each of the N—H bond of a urea functional group may be replaced by an N—Cl bond. In some embodiments, the silane-based polymer comprises Cl and urea at a w/w ratio between 1:1 (w/w) and 3:1 (w/w).

In some embodiments, the biocide comprises hydrogen peroxide, or a peroxide source. In some embodiments, the hydrogen peroxide source is selected from liquid hydrogen peroxide sources (i.e. aqueous solutions of hydrogen peroxide) and solid hydrogen peroxide sources (i.e. solid compounds that upon heating or exposure to water release hydrogen peroxide). Examples of solid hydrogen peroxide sources are, e.g., hydrogen peroxide bound in chemical compounds (e.g. a solid compound of hydrogen peroxide bound in polyvinylpyrrolidone (PVP)) and compounds with the potential of developing hydrogen peroxide, e.g. by reaction with water, such as perborates (e.g. sodium perborate), percarbonates (e.g. sodium percarbonate), peroxyphosphates (e.g. sodium peroxyphosphate), persulfates (e.g. potassium persulfate), peroxymonosulfates, peroxydisulfates, urea peroxide, etc. It should be understood that the hydrogen peroxide source referred to herein may consist of one or more of the species of sources, and possibly also a solid source combined with a liquid hydrogen peroxide source. In some embodiments, the biocide comprises a percarboxylic acid (PA), hydrogen peroxide, urea hydrogen peroxide, sodium peroxide, calcium peroxide, silver, silver salt and hydrogen peroxide (HP), sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

In some embodiments, H₂O₂ is bound to the silane-based polymer via hydrogen bond, as exemplified in non-limiting examples in

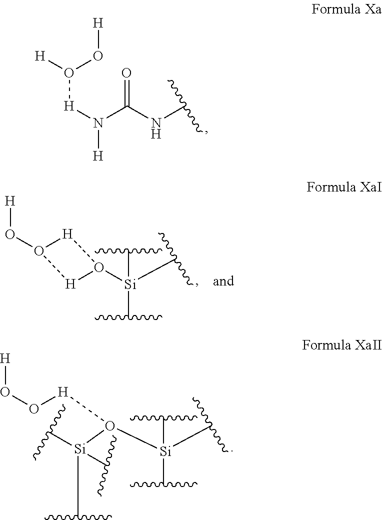

In some embodiments, the essential oil is bound to the silane-based polymer via hydrogen bond, as exemplified in in non-limiting examples in

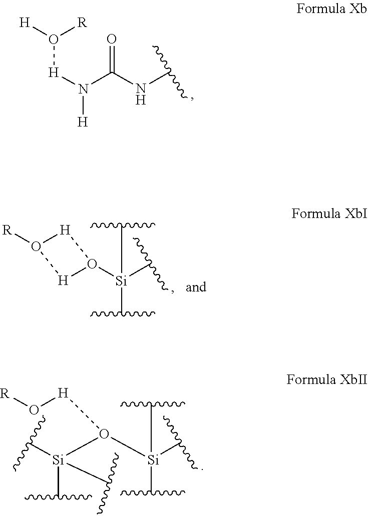

HO—R represents the EO.

As used herein, the term “essential oil (EO)” refers to a product obtained from a natural raw material of plant origin, by steam distillation, by mechanical processes from the epicarp of citrus fruits, or by dry distillation, after separation of the aqueous phase-if any—by physical processes. EOs are well-known and documented in the art and will be apparent to those skilled in the art. Essential oils suitable according to the present invention, are any essential oil characterized by biocidal activity. In some embodiments, the essential oil is selected from the group comprising thymol, arginol, lemonene, cinnamon oil, organum oil, sage oil tea tree oil, carvacrol oil, or any combination thereof.

In some embodiments, the metal ion is coordinated to the silane-based polymer. In some embodiments, the metal ion is bound to the silane-based polymer via Metal-coordination bond, as exemplified in non-limiting examples in

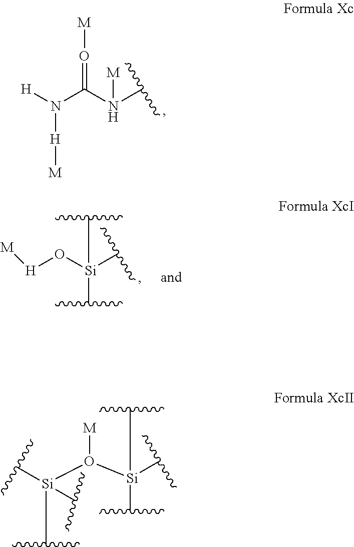

wherein M represents the metal ion.

In some embodiments, the metal ion is any biocidal metal ion. As used herein “biocidal metal ion” refers to a metal ion characterized by a biocidal activity. In some embodiments, the metal ion is selected from the group comprising Zn²⁺, Cu²⁺ or Ag⁺.

In some embodiments, “biocide” refers to a combination of two or more biocide. In some embodiments, biocide refer to a combination of two biocide. In some embodiments, the coating layer comprises two or more biocide. In some embodiments, the two or more biocide act in synergy.

In some embodiments, the composition and/or particle comprises a silane-based polymer and an essential oil at a w/w ratio between 1:50 (w/w) and 1:500 (w/w), between 1:70 (w/w) and 1:500 (w/w), between 1:100 (w/w) and 1:500 (w/w), between 1:250 (w/w) and 1:500 (w/w), between 1:50 (w/w) and 1:350 (w/w), between 1:70 (w/w) and 1:350 (w/w), between 1:100 (w/w) and 1:350 (w/w), between 1:250 (w/w) and 1:350 (w/w), including any range therebetween. Each possibility represents a separate embodiment of the invention. In some embodiments, the silane-based polymer comprises Cl and urea at a w/w ratio between 1:1 (w/w) and 3:1 (w/w). In some embodiments, a composition and/or a particle comprising Cl and an essential oil at a w/w ratio as described hereinabove, is characterized by antifungal activity, synergistic antifungal activity and/or antiviral activity. In some embodiments, the composition and/or particle comprises a silane-based polymer and thymol at a w/w ratio between 1:50 (w/w) and 1:500 (w/w), between 1:70 (w/w) and 1:500 (w/w), between 1:100 (w/w) and 1:500 (w/w), between 1:250 (w/w) and 1:500 (w/w), between 1:50 (w/w) and 1:350 (w/w), between 1:70 (w/w) and 1:350 (w/w), between 1:100 (w/w) and 1:350 (w/w), between 1:250 (w/w) and 1:350 (w/w), including any range therebetween. Each possibility represents a separate embodiment of the invention. In some embodiments, the silane-based polymer comprises Cl and urea at a w/w ratio between 1:1 (w/w) and 3:1 (w/w). In some embodiments, a composition and/or particle comprising Cl and thymol at a w/w ratio as described hereinabove, is characterized by antifungal activity, synergistic antifungal activity and/or antiviral activity.

In some embodiments, the composition and/or particle comprises a metallic ion and hydrogen peroxide at a weight per weight (w/w) ratio between 1:500 (w/w) and 1:2000 (w/w), between 1:700 (w/w) and 1:2000 (w/w), between 1:900 (w/w) and 1:2000 (w/w), between 1:1000 (w/w) and 1:2000 (w/w), between 1:500 (w/w) and 1:1500 (w/w), between 1:700 (w/w) and 1:1500 (w/w), between 1:900 (w/w) and 1:1500 (w/w), or between 1:1000 (w/w) and 1:1500 (w/w), including any range therebetween. Each possibility represents a separate embodiment of the invention. In some embodiments, the composition and/or particle comprises Ag⁺ and hydrogen peroxide at a weight per weight (w/w) ratio between 1:500 (w/w) and 1:2000 (w/w), between 1:700 (w/w) and 1:2000 (w/w), between 1:900 (w/w) and 1:2000 (w/w), between 1:1000 (w/w) and 1:2000 (w/w), between 1:500 (w/w) and 1:1500 (w/w), between 1:700 (w/w) and 1:1500 (w/w), between 1:900 (w/w) and 1:1500 (w/w), or between 1:1000 (w/w) and 1:1500 (w/w), including any range therebetween. Each possibility represents a separate embodiment of the invention. In some embodiments, a composition and/or particle comprising Ag⁺ and hydrogen peroxide at a weight per weight (w/w) ratio between 1:500 (w/w) and 1:2000 (w/w), is characterized by bactericidal activity, and/or synergistic antibacterial activity.

In some embodiments, the composition comprises a protic solvent selected from the group consisting of: water, ethanol, methyl ethyl ketone, isopropanol, methanol, butanol and any combination thereof.

In some embodiments, the composition comprises water and ethanol at a volume per volume (v/v) ratio between 1:2 (v/v) and 1:20 (v/v), between 1:3 (v/v) and 1:20 (v/v), between 1:5 (v/v) and 1:20 (v/v), between 1:8 (v/v) and 1:20 (v/v), between 1:2 (v/v) and 1:18 (v/v), between 1:3 (v/v) and 1:18 (v/v), between 1:5 (v/v) and 1:18 (v/v), between 1:8 (v/v) and 1:18 (v/v), between 1:2 (v/v) and 1:15 (v/v), between 1:3 (v/v) and 1:15 (v/v), between 1:5 (v/v) and 1:15 (v/v), or between 1:8 (v/v) and 1:15 (v/v), including any range therebetween. Each possibility represents a separate embodiment of the invention.

In some embodiments, the composition comprises between 0.01% (w/w) and 0.2% (w/w), between 0.05% (w/w) and 0.2% (w/w), between 0.09% (w/w) and 0.2% (w/w), between 0.1% (w/w) and 0.2% (w/w), 0.01% (w/w) and 0.1% (w/w), between 0.05% (w/w) and 0.1% (w/w), or between 0.09% (w/w) and 0.1% (w/w) of a surfactant, including any range therebetween. Each possibility represents a separate embodiment of the invention. In some embodiments, the surfactant is a cationic surfactant. In some embodiments, the surfactant is selected from the group consisting of: cetyltrimethylammonium bromide (CTAB), cetyltrimethylammonium chloride (CTACI), tetradecyltrimethylammonium bromide (TTAB), tetradecyltrimethyl ammonium chloride (TTACl), dodecyltrimethylammonium bromide (DTAB), dodecyl trimethylammonium chloride (DTACl), dodecylethyidimethylammonium bromide (DEDTAB), decyltrimethylammonium bromide (DOTAB), dodecyl triphenylphosphonium bromide (DTPB), polyvinylpyrrolidone (PVP), and any salt or any combination thereof.

In some embodiments, the composition comprises a base. In some embodiments, the composition comprises between 5 mM and 40 mM, between 7 mM and 40 mM, between 10 mM and 40 mM, between 15 mM and 40 mM, between 20 mM and 40 mM, between 5 mM and 15 mM, between 7 mM and 15 mM, or between 10 mM and 15 mM, of a base, including any range therebetween. Each possibility represents a separate embodiment of the invention. In some embodiments, the base is selected from NH₄OH, KOH, NaOH, or a combination thereof.

In some embodiments, the composition is an antimicrobial composition, synergistic antimicrobial composition, antibiofilm composition, bacteriostatic composition, fungicidal composition, fungistatic composition, pesticide composition, antiviral composition, or any combination thereof.

In some embodiments, the coating and/or the substrate in contact therewith is a thermal adhesive. In some embodiments, the coating is a heat sealant. In some embodiments, a plurality of coating surfaces have adhesiveness to each other when heated to an appropriate temperature. In some embodiments, the coating is a thermal adhesive, having adhesiveness to a substrate (e.g. a glass substrate and/or a polymeric substrate).

In some embodiments, the coating surface is heat sealable (e.g. a plurality of surfaces adhere to each other or to a substrate), upon heating thereof to an appropriate temperature.

In some embodiments, the composition and/or coating of the invention is thermally curable (e.g. upon heating to an appropriate temperature). In some embodiments, the appropriate temperature is between 70 and 200° C., between 100 and 150° C., between 150 and 200° C., between 70 and 80° C., between 80 and 90° C., between 90 and 100° C., or about 160-190° C., including any range between. In some embodiments, the composition and/or coating of the invention is a thermal adhesive.

In some embodiments, the thermally curable composition and/or coating of the invention comprises the mesoporous silica matrix, and further comprises the stabilizer and/or the additional polysiloxane, wherein the stabilizer and the additional polysiloxane are as described herein.

In some embodiments, the composition has adhesiveness to a substrate (glass substrate, a coated substrate of the invention, a polymeric substrate. In some embodiments, the composition is for use as a thermally curable adhesive for adhesion or sealing of one or more substrate surfaces.

In some embodiments, a particle as described herein is substantially stable (e.g., the particle substantially maintains its structural and/or functional properties, such as stability of the particle) for at least one week (w), at least 2 w, least one month (m), at least 2 m, at least 6 m, at least 12 m, at least 2 years (y), at least 3 y, at least 10 y, including any range therebetween, wherein substantially is as described hereinbelow. Each possibility represents a separate embodiment of the invention.

In some embodiments, the particle is substantially stable upon exposure to (i) organic materials, (ii) microbial loading cycles or a combination of (i) and (ii). In some embodiments, the particle substantially maintains its biocidal activity upon exposure to (i) organic materials, (ii) microbial loading cycles or a combination of (i) and (ii). In some embodiments, the term “stable” refers to the ability of the particle to substantially maintain its structural, physical, biological and/or chemical properties.

In some embodiments, a particle comprising a polymer as described herein and a biocide is characterized by an improved biocidal activity, as compared to a reference biocide. In some embodiments, a particle comprising a polymer as described herein and a biocide is characterized by an improved stability, as compared to a reference biocide. In some embodiments, the composition is characterized by a stability (e.g., shelf life) of at least 2 months, at least 3 months, at least 4 months, at least 5 months, at least 6 months, at least 1 year, at least 2 years, at least 5 years, or at least 10 years including any value therebetween. Each possibility represents a separate embodiment of the invention. In some embodiments, the shelf live is extended by at least 1 day, at least 5 days, at least 10 days, at least 20 days, at least 50 days, at least 2 months, at least 3 months, at least 5 months, or at least 1 year, including any value therebetween. Each possibility represents a separate embodiment of the invention.

### Antimicrobial Activity

According to an aspect of some embodiments of the present invention there is provided a method of inhibiting or reducing or retarding the formation of load of a microorganism and/or the formation of a biofilm, in and/or on an article. In some embodiments, the method comprises contacting the article with any one of the coated substrate disclosed herein. In some embodiments, the method comprises contacting the article with any one of the compositions disclosed herein.

According to an aspect of some embodiments of the present invention there is provided a method of inhibiting or reducing the formation of load of a microorganism in a plant or food product. In some embodiments, the method comprises contacting the plant or food product with any one of the coated substrate disclosed herein. In some embodiments, the method comprises contacting the plant or food product with any one of the compositions disclosed herein.

According to an aspect of some embodiments of the present invention there is provided a method of preserving a food product, comprising adding to the food product any one of the coated substrates or compositions disclosed herein.

In some embodiments, the components in the coating layer of the coated substrate or in the composition act in synergism. In some embodiments, the two or more biocides in the coating layer of the coated substrate or in the composition act in synergism.

In some embodiments, the term synergism, or any grammatical derivative thereof, is defined as the simultaneous action of two or more compounds in which the total response of an organism to the combination is greater than the sum of the individual components. Although many combinations of antimicrobial compounds have been studied, a synergistic effect is rarely revealed and the global use of antimicrobial combinations with synergistically enhanced activity is rather limited.

Herein “antimicrobial activity” is referred to as an ability to inhibit (prevent), reduce or retard bacterial growth, fungal growth, biofilm formation or eradicate living bacterial cells, or their spores, or fungal cells or viruses in a suspension or in a moist environment. Herein, inhibiting or reducing or retarding the formation of load of a microorganism refers to inhibiting, reducing, or retarding growth of microorganisms and/or eradicating a portion or all of an existing population of microorganisms. Thus, formulations described herein can be used both in reducing the formation of microorganisms on, or in an article, and in killing microorganisms in, or on an article.

The microorganism can be, for example, a unicellular microorganism (prokaryotes, archaea, bacteria, eukaryotes, protists, fungi, algae, molds, yeast, euglena, protozoan, dinoflagellates, apicomplexa, trypanosomes, amoebae and the likes), or a multicellular microorganism.

The term “biofilm”, as used herein, refers to an aggregate of living cells which are stuck to each other and/or immobilized onto a surface as colonies. The cells are frequently embedded within a self-secreted matrix of extracellular polymeric substance (EPS), also referred to as “slime”, which is a polymeric sticky mixture of nucleic acids, proteins and polysaccharides.

In the context of the present embodiments, the living cells forming a biofilm can be cells of a unicellular microorganism (prokaryotes, archaea, bacteria, eukaryotes, protists, fungi, algae, euglena, protozoan, dinoflagellates, apicomplexa, trypanosomes, amoebae and the likes), or cells of multicellular organisms in which case the biofilm can be regarded as a colony of cells (like in the case of the unicellular organisms) or as a lower form of a tissue.

In the context of the present embodiments, the cells are of microorganism origins, and the biofilm is a biofilm of microorganisms, such as bacteria and fungi. The cells of a microorganism growing in a biofilm are physiologically distinct from cells in the “planktonic form” of the same organism, which by contrast, are single-cells that may float or swim in a liquid medium. Biofilms can go through several life-cycle steps which include initial attachment, irreversible attachment, one or more maturation stages, and dispersion.

The phrase “antibiofilm formation activity” refers to the capacity of a substance to affect the prevention of formation of a biofilm of bacterial, fungal and/or other cells, and/or to affect a reduction in the rate of buildup of a biofilm of bacterial, fungal and/or other cells, on a surface of or in a substrate/article.

As used herein, the term “preventing” in the context of antimicrobial, indicates that the growth rate of the microorganism cells is essentially nullified or is reduced by at least 20%, at least 30%, at least 40%, at least 50%, at least 60%, at least 70%, at least 80%, at least 90%, including any value therebetween, of the appearance of the microorganism in a comparable situation lacking the presence of formulation or an article containing same. Alternatively, preventing means a reduction to at least 15%, 10%, or 5% of the appearance of the microorganism cells in a comparable situation lacking the presence of the formulation or an article containing same. Methods for determining a level of appearance of a microorganism cells are known in the art. Such articles take advantage of the improved antimicrobial activity exhibited by the compositions and coated substrates as described herein.

### Definitions

As used herein, the term “alkyl” describes an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atoms, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein.

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted, as indicated herein.

The term “alkoxy” describes both an —O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule. Additional substituents are also contemplated.

The term “halide”, “halogen” or “halo” describes fluorine, chlorine, bromine or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “thiohydroxy” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amine” describes a —NR′R″ group, with R′ and R″ as described herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino and the like.

The term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” describes a —C(═O)—R′ group, where R′ is as defined hereinabove.

The above-terms also encompass thio-derivatives thereof (thiocarboxy and thiocarbonyl).

The term “thiocarbonyl” describes a —C(═S)—R′ group, where R′ is as defined hereinabove.

A “thiocarboxy” group describes a —C(═S)—OR′ group, where R′ is as defined herein.

A “sulfinyl” group describes an —S(═O)—R′ group, where R′ is as defined herein.

A “sulfonyl” or “sulfonate” group describes an —S(═O)₂—R′ group, where Rx is as defined herein.

A “carbamyl” or “carbamate” group describes an —OC(═O)—NR′R″ group, where R′ is as defined herein and R″ is as defined for R′.

A “nitro” group refers to a —NO₂ group.

A “cyano” or “nitrile” group refers to a —C≡N group.

As used herein, the term “azide” refers to a —N₃ group.

The term “sulfonamide” refers to a —S(═O)₂—NR′R″ group, with R′ and R″ as defined herein.

The term “phosphonyl” or “phosphonate” describes an —O—P(═O)(OR′)₂ group, with R′ as defined hereinabove.

The term “phosphinyl” describes a —PR′R″ group, with R′ and R″ as defined hereinabove.

The term “alkaryl” describes an alkyl, as defined herein, which substituted by an aryl, as described herein. An exemplary alkaryl is benzyl.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

As used herein, the terms “halo” and “halide”, which are referred to herein interchangeably, describe an atom of a halogen, that is fluorine, chlorine, bromine or iodine, also referred to herein as fluoride, chloride, bromide and iodide.

The term “haloalkyl” describes an alkyl group as defined above, further substituted by one or more halide(s).

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

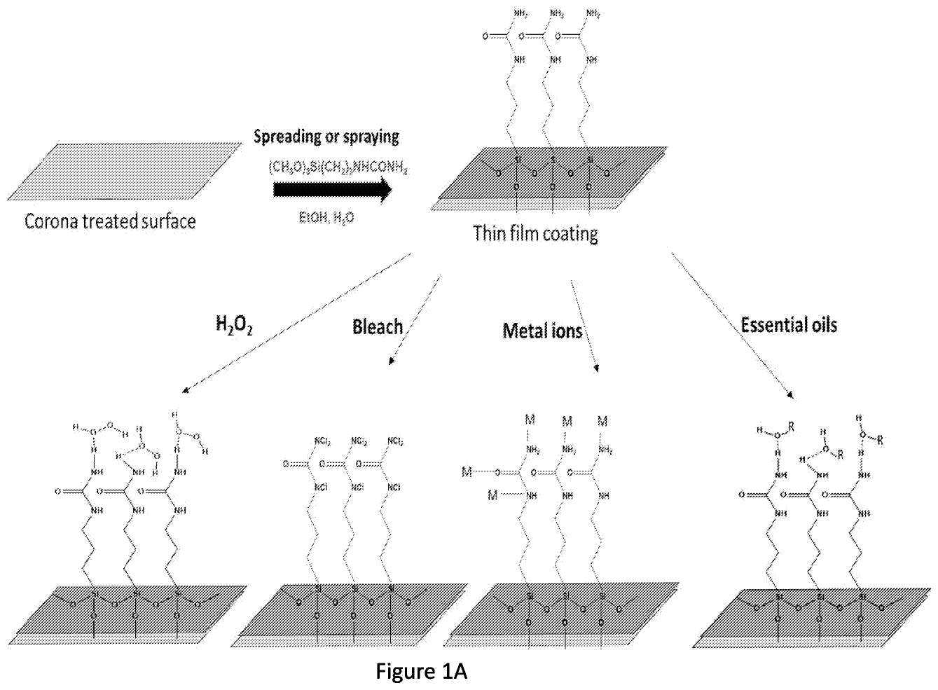

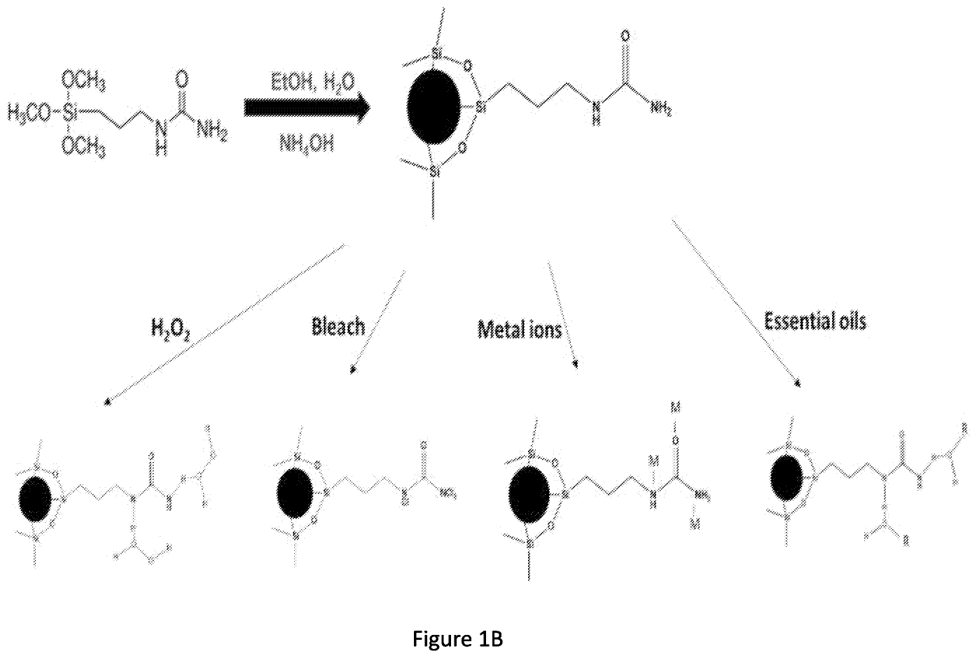

Nano/micro-particles (N/MPs) and thin coatings on different polymeric films were prepared in order to impart disinfectant properties on the film's surface. The particles and coatings are based on silane polymers containing urea functional groups. The coatings divided into 4 types that release different biocide chemicals: activated chlorine, hydrogen peroxide, essential oils and metal ions. All types of coatings illustrated biocidal effects against microorganisms and decrease/prevent biofilm formation. Synergetic anti-microbial effects were achieved by combining different types of coatings. FIG. 1A describes the four types of coatings prepared in the present work. Similar nano/micro-particles were also prepared.

The present work describes the fabrication of novel re-chargeable N/MPs and thin coatings based on crosslinked silane polymers containing urea functionality onto polymeric films, e.g., PE, PP, PC, PVC, PMMA, PET, etc., as well as metal oxides, e.g. iron oxide, titanium oxide, copper odixe, and aluminum oxide.

N-halamine N/MPs and coatings were prepared by modified Stöber polymerization process of 1-[3-(trimethoxysilyl)propyl] urea (TMSPU) in absence or presence of tetraethylorthosilicate (TEOS) in an Ethanol/H₂O continuous phase. Four types of coatings and particles were prepared for releasing different biocidal chemicals: activated chlorine, hydrogen peroxide, essential oils and metal ions (FIG. 1B). These 4 types of N/MPs and thin coatings were found to be extremely potent against bacteria, e.g., Escherichia coli and Staphylococcus aureus as well as against multidrug-resistant bacteria, fungi and viruses. It should be noted that synergistic N/MPs and coatings composed of dual functionality, e.g., coatings onto PE films containing both activated Cl and essential oils, PE/(SiO₂-urea+thymine), were also produced and were very efficient as antibiofilm formation.

Chlorine-releasing coatings and particles were prepared by chlorination of polymeric films coated with polySiO₂-urea (e.g., PP/SiO₂-urea) via NaOCl. In the current study, the inventors further characterized the anti-microorganism potential of P(TEOS/TMSPU)-Cl NPs and P(TMSPU)-Cl coatings in comparison to free NaOCl (bleach), one of the most widely used disinfectants in medical, industrial, and domestic settings. The inventors show that the nano/micro-scale P(TEOS\TMSPU)-Cl and P(TMSPU)-Cl coatings retains potent antimicrobial activity even after exposure to organic materials and repetitive microbial loading cycles as compared to bleach, which is highly labile under these conditions, losing its biocidal activity rapidly.

Hydrogen peroxide-releasing coatings were produced by first fabricating the SiO₂-urea coating onto different polymeric films. The coated films were then reacted with hydrogen peroxide to form a complex with the urea functional groups, resulting in a polymer film coated with layer/s of urea-hydrogen peroxide. Alternatively, silver ions were introduced to the hydrogen peroxide solution which enhances the stabilization of the hydrogen peroxide molecules as well as the bactericidal effect as previously explained. These coated films (e.g., PE/SiO₂-urea-hydrogen peroxide and PE/SiO₂-urea-hydrogen peroxide/Ag⁺) were then coated with a paraffin wax/surfactant mixture, enabling the insulation of the hydrogen peroxide-urea adduct.

Essential oil-releasing coatings were produced by adding oils, e.g. thymol, arginol, lemonen, etc., into the initial SiO₂-urea coating solution. In this study, the inventors show that the coatings containing essential oils exhibit anti-fungal activity. In addition, the inventors found that when thymol oil was added to chlorine-releasing coatings, a synergistic effect against fungi and viruses was observed.

Metal ions, e.g., Zn²⁺ or Ag⁺, were chelate to the SiO₂-urea coatings by mixing methanolic or ethanolic solutions of AgNO₃ (0.01 mole) or ZnCl₂ (0.01 mole) with the SiO₂-urea coating films (e.g., PE/SiO₂-urea) The mixtures were allowed to be shaken for about 4 hours at room temperature. The PE/SiO₂-urea-M film were then washed from excess reagents and then dried.

### Preparation of Core and Core Shell Silica Urea Particles

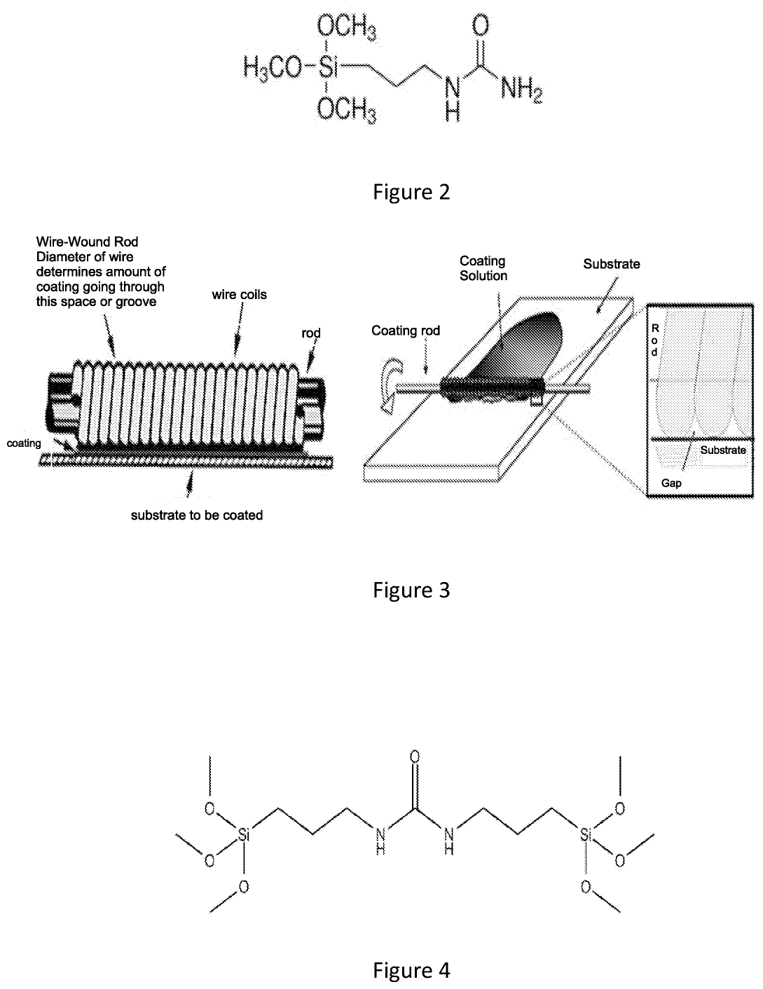

SiO₂-urea N/MPs were prepared using a modified Stöber polymerization process of tetraethylorthosilicate (TEOS) and 1-[3-(Trimethoxysilyl)propyl] urea (TMSPU) (FIG. 2). In a typical experiment, core particles were prepared by different amounts of ethanol absolute, deionized water, ammonium hydroxide, TEOS and TMSPU were added to a tube (Table 1) and shaken at room temperature for four hours. The formed SiO₂-urea N/MPs were then transferred to water by ethanol evaporation. Table 1, experiments 1-3 summarizes the different conditions used to prepare different sizes of the core SiO₂-urea particles.

Core/shell SiO₂ urea NPs/MPs were prepared in two stages. First, the core SiO₂ NPs/MPs were prepared using a modified Stöber polymerization of tetraethylorthosilicate (TEOS). Thereafter, 1-[3-(Trimethoxysilyl)propyl] urea (TMSPU) was add to the tube and polymerized onto the previously produced SiO₂ N/MPs. The formed SiO₂-urea core/shell N/MPs were then transferred to water by ethanol evaporation. Table 1, examples 4-5 summarizes the different conditions used to prepare different sizes of the core/shell SiO₂-urea particles.

TABLE 1
Synthetic parameters used to form SiO₂ urea NPs of different sizes.

| Sample | Ethanol | H₂O | NH₄OH | TEOS | TMSPU |
|---|---|---|---|---|---|
| number | (mL) | (mL) | (mL) | (mL) | (mL) |
| 1 | 23.5 | 0.4 | 0.7 | 0.72 | 0.08 |
| 2 | 23.5 | 0.4 | 0.7 | 0.64 | 0.16 |
| 3 | 23.5 | 0.4 | 0.7 | 0.4 | 0.4 |
| 4 | 23.5 | 0.4 | 1 | 0.8 | 0.125 |
| 5 | 23.5 | 0.4 | 1 | 0.8 | 0.25 |

### Characterizations of the Sio₂-Urea N/MPs

### Dynamic Light Scattering (DLS)

The hydrodynamic diameter and diameter distribution of the N/MPs were measured by dynamic light scattering (DLS) with photon cross-correlation spectroscopy (Nanophox particle analyzer, Sympatec GmbH, Germany).

### High Resolution Scanning Electron Microscope (HRSEM)

For imaging (dry diameter and size distribution) and morphological characterization of the colloidal SiO₂-urea N/MPs, high resolution scanning electron microscope (HRSEM) images were taken using a FEI XHR-SEM Magellan 400 L scanning electron microscope operating at 5 kV. A drop of dilute aqueous samples was spread on a silicon wafer, and then dried at room temperature. The dried samples were coated with iridium in vacuum before viewing under HRSEM.

Preparation of Silica-Urea Coatings onto Different Polymeric Films

SiO₂-urea coatings were prepared on various polymeric films, e.g., PE, PP, PET, PC, PVC or metal oxides (e.g. aluminum oxide), titanium and glass using a modified Stöber polymerization process of 1-[3-(Trimethoxysilyl)propyl] urea (TMSPU). In a typical experiment, surface oxidation was first done by corona (200-600 W min/m²) or plasma (O₂) treatment. The surface oxidized films were then coated by different techniques such as dipping, spraying or mayor rod methods. For all coating methods, different amounts of ethanol absolute, deionized water, ammonium hydroxide (or sodium hydroxide) and TMSPU were added to the tube (Table 2) and mixed. Table 2 and 3 summarize the conditions used to prepare the SiO₂-urea coatings.

TABLE 2
Synthetic parameters used to form
SiO₂-urea coatings onto polymeric films.

| Sample | Ethanol | H₂O | NH₄OH | TMSPU |
|---|---|---|---|---|
| number | (mL) | (mL) | (mL) | (mL) |
| 1 | 18.75 | 3 | 0.675 | 1.5 |
| 2 | 18.75 | 3 | 0.675 | 0.75 |
| 3 | 18.75 | 3 | 0.675 | 0.5 |
| 4 | 18.75 | 3 | 0.675 | 0.125 |
| 5 | 23.5 | 0.4 | 0.7 | 0.8 |
| 6 | 18.75 | 6.65 | 0.45 | 1.5 |
| 7 | 18.75 | 1 | 0.8 | 1.5 |
| 8 | 18.75 | 3 | 0.675 | 0.125 |

### Dipping

SiO₂-urea coatings were prepared using a modified Stöber polymerization process of TMSPU in the presence of different polymeric films (e.g., PE, PP and PET) or metal oxides (e.g. aluminum oxide), titanium and glass. After the surface were oxidized, e.g., treated with corona or plasma the surfaces inserted into a tube containing different amounts of ethanol absolute, deionized water, ammonium hydroxide (or sodium hydroxide) and TMSPU (Table 2) and shaken at room temperature for different time periods (1, 3 and 12 h) Following this coating process, the substrate was dried in a heating oven at 80-120° C. for a few minutes. The formed SiO₂-urea surfaces were then washed with water and air-dried. Table 2 summarizes the different conditions used to prepare SiO₂-urea coatings.

### Spreading/Rod-Coating Technique

Surfaces or films were coated by spreading with a coating rod method. A Mayer rod is a metal bar with a wire wrapped around it that is used to draw a solution over a substrate surface (FIG. 3). The diameter of the wire wrapped around the bar determines the thickness of the wet coating film. In this study, the film was pre-treated by oxidation, e.g., air corona or plasma to improve the adhesion of the coatings. After that, a mixture of different amounts of absolute ethanol, deionized water, ammonium hydroxide (or sodium hydroxide) and TMSPU (Table 2) was prepared. Then, (after 1.5 h) the mixture was spread onto the surface of the substrate by using Mayer rod (RK Print Coat Instruments Ltd., Litlington, Royston). Following this coating process, the substrate was dried in a heating oven at 80-120° C. for a few minutes. The formed SiO₂-urea surfaces were washed with water and air-dried. Table 2 summarizes the different conditions used to prepare the SiO₂-urea coatings.

The Rods are available in a wide variety of wire sizes to give a range of coating thickness. Table 3 below shows the wire sizes that are available and the coating thickness that can be achieved. The dry thickness is determined by the concentration of the solid in the coating solution. In this study, uniform layers with wet variety thicknesses were prepared.

TABLE 1
Number of the rod, wire sizes diameter that are available
and the wet thickness films that can be achieved.

| | Wire | Wet Film |
|---|---|---|
| | Diameter | Deposit |
| Bar No. | (mm) | (μm) |
| 0 | 0.05 | 4 |
| 1 | 0.08 | 6 |
| 2 | 0.15 | 12 |
| 3 | 0.30 | 24 |
| 4 | 0.51 | 40 |
| 5 | 0.64 | 50 |
| 6 | 0.76 | 60 |
| 7 | 1.02 | 80 |
| 8 | 1.27 | 100 |
| 9 | 1.52 | 120 |
| 150 | 0.25 | 150 |
| 200 | 0.36 | 200 |
| 300 | 0.51 | 300 |
| 400 | 0.76 | 400 |
| 500 | 1.00 | 500 |

### Spray

A mixture as described herein was prepared. Then, the mixture was sprayed on the surface of the corona treated polymeric films (after 1.5 h) by using a commercial spraying bottle. Following this coating process, the substrate was dried in a heating oven at 80-120° C. for a few minutes. The formed SiO₂ urea surfaces were washed with water and air-dried. Table 2 summarizes the different conditions used to prepare the SiO₂-urea coatings.

Additionally, mesoporous SiO₂-urea N/MPs and coatings were prepared according to the parameters described in Table 2, experiment 1 with the addition of different amounts of cetyltrimethylammonium bromide (CTAB) in the initial solution (Table 4).

TABLE 4
Synthetic parameters used to form mesoporous
SiO₂-urea coatings and N/MPs.

| Sample | Ethanol | H₂O | NH₄OH | TMSPU | CTAB |
|---|---|---|---|---|---|
| number | (mL) | (mL) | (mL) | (mL) | (mg) |
| 1 | 18.75 | 3 | 0.675 | 1.5 | 224 |
| 2 | 18.75 | 3 | 0.675 | 1.5 | 22.4 |
| 3 | 18.75 | 3 | 0.675 | 1.5 | 2.24 |

SiO₂-urea coatings and N/MPS were also prepared by substituting TMSPU monomer for TMSPU+NTMSPU (FIG. 4), according to the description in Table 5. Additionally, SiO₂-urea coatings and N/MPS were also prepared by substituting TMSPU monomer for NTMSPU (FIG. 4).

Additionally, SiO₂-urea coatings and N/MPS were also prepared by adding PVP (up to 1%).

TABLE 5
Synthetic parameters used to form
SiO₂ urea coatings with NTMSPU.

| Sample | Ethanol | H₂O | NH₄OH | TMSPU | NTMSPU |
|---|---|---|---|---|---|
| number | (mL) | (mL) | (mL) | (mL) | (mg) |
| 1 | 18.75 | 3 | 0.675 | 1.2 | 0.3 |
| 2 | 18.75 | 3 | 0.675 | 0.75 | 0.75 |

### Characterization of the Coatings

### High Resolution Scanning Electron Microscope (HRSEM)

For characterization of the coated films, films were attached to the silicon wafer with carbon tape, coated with iridium in vacuum and then studied by HRSEM.

### Attenuated Total Reflectance (ATR)

ATR measurements of the coated and uncoated PE films were done using a Bruker ALPHA-FTIR QuickSnap sampling module equipped with a Platinum ATR diamond module.

### Contact Angle (CA)

Sessile drop water contact angle measurements were performed using a Goniometer (System OCA, model OCA20, Data Physics Instruments Gmbh, Filderstadt, Germany). Double distilled water drops of 5 μl were placed on three different areas of each film and images were captured a few seconds after deposition. The static water contact angle values were determined by Laplace-Young curve fitting. All measurements were done at same conditions.

### Durability of the Coatings

Adhesion tests were done to examine the strength of the interaction between the SiO₂-urea coating and the polymeric film. The test consisted of firmly pressing an adhesive tape onto the coated film then slowly peeling it off. In addition, durability of the coatings in water was tested, the coatings soaked in water for a week and after that dried and tested in FTIR.

### Preparation of Chlorine-Releasing Coatings/Particles

### Chlorination of the Coatings/Particles

After completion the preparation of the particles and the coatings activated chlorine binding to the amide groups belonging to the urea groups was done by a chlorination process, as follows: sodium hypochlorite aqueous solution (0.1-5% w/v) was added to a vial containing 1 cm² coated film or 1 mL aqueous dispersion of the silica-urea N/MPs. The vial was then shaken at 25-45° C. for different time periods, 1, 3, 6 and 12 h. Excess sodium hypochlorite was removed from the coatings by extensive washing of the chlorinated coated films water and for the N/MPs by extensive dialysis against water. The bound chlorine content of the coatings or particles was then determined by iodometric/thiosulfate titration according to the literature³⁴, as follows:

$$[ {Cl}^{+} ] ( m M ) = \frac{N \times V \times 1000}{2} ,$$

where N is the normality and Vis the volume of the titrated sodium thiosulfate solution.

### Chlorination/Re-Charging Cycles of the Coatings/Particles

Five chlorination/de-chlorination cycles were performed with the N/MPs and coatings. In brief, for the particles, 20 mL of the silica-urea N/MPs aqueous dispersion (10 mg/mL) were chlorinated with 20 mL of sodium hypochlorite aqueous solution (0.5% w/v pH 8-9). Excess reagents were removed from the particle aqueous dispersion by extensive dialysis against water. Analysis of the bound Cl content of the silica-urea-Cl particles was accomplished via iodometric/thiosulfate titration. Cl Re-charging of the silica-urea particles after loss of all the bound Cl was done by repeating the first Cl charging process. This chlorination/de-chlorination process was repeated another ten times.

For the coatings, 1 cm² coated film was chlorinated with 5 mL of sodium hypochlorite aqueous solution (0.5% w/v pH 7-8), followed by the removal of excess hypochlorite according to the previous description. The analysis of the bound Cl content of the silica-urea-Cl coatings were determined via iodometric/thiosulfate titration and after that were de-chlorinated by shaking this coating for 5 min with 5 mL of 0.1 N sodium thiosulfate solution according to the literature. Excess reagents were removed from the coating by extensive wash against water. This chlorination/de-chlorination process was repeated another ten times.

### Preparation of Hydrogen Peroxide-Releasing Coatings

### Hydrogen Peroxide Addition to the SiO₂-Urea Coatings/Particles

After preparation of the SiO₂-urea coatings, adduct of hydrogen peroxide to the amide urea groups was done by a complexation process, as follows:

Hydrogen peroxide aqueous solution (15% w/w) was added to a 20 ml vial with 20 cm² SiO₂-urea coated film or 1 mL aqueous dispersion of the silica-urea N/MPs. the vial was then incubated in water bath on hot plate, preset to just below 60° C. (thermometer added to water bath) and magnetic stirring, after reaction solution has reached the desired temperature, the SiO₂-urea coated film was added and let reaction for about 5 minutes. The solution containing the SiO₂-urea-H₂O₂ coated film cooled down to room temperature in the reaction vessel. The coated film was then removed, washed and then dried with N₂ flow and kept in desiccator. The Hydrogen peroxide content in the coating film were determined by KMnO4 titration according to the literature³⁸, as follows: sodium oxalate first used as standard solution, in order to determine potassium permanganate content.
n_{KMnO4}=2.5×C_{Na2C2O4}×V_{Na2C2O4}, where C_{Na2C2O4} is titrant solution concentration and V_{Na2C2O4} is the volume of the titrant required to titrate the KMnO4.
nH₂O₂=2.5×C_{KMno4}×V_{KMno4}, where Cₖₘₙ₀₄ is titrant solution concentration and V_{KMnO4} is the volume of the titrant required to titrate the H₂O₂.

For titration done to sample in the size of 3.5×4 cm² (14 cm²) added to 20 mL vial, about 11.9 ml of DDW to the vial and 650 μl of 96% H₂SO₄, used magnetic stirrer.

The KMnO₄ titrant dilution is as follow: KMₙO₄ stock solution: about 790 mg of KMₙO4 diluted with 10 ml of DDW. (dilution:1)

KMₙO4 titration solution: about 1 ml from stock solution diluted with 19 ml of DDW (total dilution:20).

### Preparation of Essential Oils-Releasing Coatings

### Essential Oils Addition to the SiO₂-Urea Coatings/NMPs

SiO₂-urea coatings with essential oils were prepared on various polymeric films, e.g., PE, PP and PET, using a modified Stöber polymerization process of 1-[3-(Trimethoxysilyl)propyl] urea (TMSPU). In a typical experiment, the films were first treated with corona (200-600 W min/m²) or plasma (O₂) and then coated by different techniques such as dipping, spray or mayor rod methods. For all coating methods, different amounts of ethanol absolute, deionized water, ammonium hydroxide (or sodium hydroxide), TMSPU and essential oils were added to the vial (Table 6) and mixed. Table 6 summarizes the conditions used to prepare the essential oils-releasing coatings with a 400 μm Mayer rod.

TABLE 6
Synthetic parameters used to form SiO₂-urea-essential
oil coatings onto PE films

| Sample | Ethanol | H₂O | NH₄OH | TMSPU | CTAB | Oil |
|---|---|---|---|---|---|---|
| number* | (mL) | (mL) | (mL) | (mL) | (mg) | (g) |
| 1 | 18.75 | 3 | 0.675 | 1.5 | 60 | 0.7 |
| | | | | | | Thymol |
| 2 | 18.75 | 3 | 0.675 | 1.5 | 60 | 1.5 |
| | | | | | | Thymol |
| 3 | 18.75 | 3 | 0.675 | 1.5 | 60 | 2 |
| | | | | | | Thymol |
| 4 | 18.75 | 3 | 0.675 | 1.5 | 200 | 1.5 |
| | | | | | | Thymol |
| 5 | 18.75 | 3 | 0.675 | 1.5 | 200 | 1.5 |
| | | | | | | Arginol |
| 6 | 18.75 | 3 | 0.675 | 1.5 | 200 | 1.5 |
| | | | | | | Limonene |

### Preparation of Chlorine-Releasing/Essential Oil Coatings (PE/SiO₂-Urea-Cl-Thymol)

In this work, coatings containing dual activities: release of activated Cl and essential oil prepared in order to investigate a possible synergistic effect. The essential oils were adsorbed within the chlorine-releasing coatings. Table 7 shows the quantities of the various reagents.

TABLE 7
Synthetic parameters used to form SiO₂-urea-essential oil coatings

| Sample | Ethanol | H₂O | NH₄OH | TMSPU | Oil |
|---|---|---|---|---|---|
| number* | (mL) | (mL) | (mL) | (mL) | (g) |
| 1 | 18.75 | 3 | 0.675 | 1.5 | 0.25 |
| | | | | | Thymol |

### Modified Paraffin Wax Mixtures as Water Protectant Coatings

The use of paraffin wax is widely known, as water repellent agent, due to its non-polar hydrophobic hydrocarbon structure. Due to these properties, the challenge of surfaces coated with polar moieties, such as chlorine and hydrogen peroxide, requires modifications to combine the non-polar paraffin wax. The addition of non-ionic surfactants to the solution yielded a compatible wax coating to the polar surface. Eventually, the modified paraffin wax coating on the SiO₂-urea-Cl surface, protects and prevents, or decreases the rate of the chlorine release. For using these coating for antibiofilm applications the wax coating has to be removed by heating.

### Preparation of the Modified Paraffin Wax Mixtures

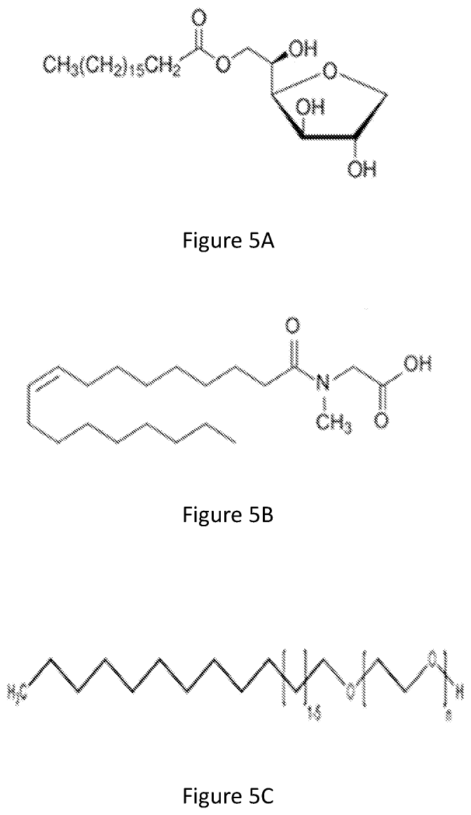

Polymeric films coated with SiO₂-urea containing either chlorine or hydrogen peroxide, separately, were used to apply a second protective coating of paraffin wax. Briefly, 5% (w/w) of surfactants, e.g. Sarkosyl O, Merpol A and SPAN 60 (FIGS. 5A-C), were added to vials containing the paraffin wax. The samples were melted in a silicone oil bath (65° C.) and homogenize with a magnetic stirrer on a hot plate. The molten mixture was spread on the different coatings (chlorine and hydrogen peroxide) using mayer rod 1 (Table 3) then were left to dry at room temperature.

Modified PE/SiO₂-Urea-Cl, PE/SiO₃-Urea-Thymol and PE/SiO₂-Urea-Cl-Thymol for Decreasing the Release Rate of Cl, Thymol or Both

These coatings were prepared as previously described, in presence of the PVP (polyvinylpyrrolidone) 0.1-1% of molecular weight above 5000 (e.g. 360000). The coated PVP decreased the release rate of the activated Cl, thymol or both. The higher the PVP molecular weight or concentration, the slower is the release of the activated Cl, thymol or both.

### Preparation of Ag⁺/Hydrogen Peroxide-Releasing Coatings

Coatings onto polymeric films composed of combination of 1:1000 [Ag⁺]:[hydrogen peroxide] (w/w) were prepared in a similar way described for the SiO₂-urea-H₂O₂ coatings substituting the aqueous hydrogen peroxide aqueous solution for hydrogen peroxide aqueous solution containing Ag⁺ in a weight ratio of 1:1000. These coatings exhibited higher bacteria inactivation performance than the sum of inactivation levels of the separate disinfectants (synergistic effect). Moreover, the addition of silver ions to hydrogen peroxide stabilized the hydrogen peroxide for longer periods.

### Example 1

### Characterization of the Silica-Urea N/MPs

### Effect of Weight Ratio [TEOS] [TMSPU] on Particle Size and Size Distribution

Core and core/shell silica-urea N/MPs were prepared using a modified Stöber polymerization process of tetraethylorthosilicate (TEOS) and 1-[3-(Trimethoxysilyl)propyl] urea (TMSPU) as described in Table 1. The weight ratio between the two monomers ([TEOS]/TMSPU]) was varied from 9/1 to 1/1 while the total monomers concentration was constant. Reducing this ratio above 4/1 resulted in the formation of agglomerated particles. Table 8 presents the effect of the weight ratio of [TEOS]/[TMSPU] on the diameter and size distribution of the formed silica-urea particles. The results suggest that the diameter and size distribution increasing as the weight ratio [TEOS]/TMSPU] decreased. For example, when the [TEOS]/TMSPU] ratio was 9:1 the average size and size distribution of the obtained particles was 33±4.2 nm, while in ratio of 4:1 the average size was increased to 283±51 nm and in ratio of 1:1 agglomerated particles were formed. Experiments 1-3 relate to the core silica-urea particles while experiments 4-5 r relate to the core shell particles.

TABLE 8
Hydrodynamic diameters of the SiO₂-urea particles as function
of the weight ratio [TEOS]/[TMSPU].

| | | | | | | [TEOS/ | Hydrodynamic |
|---|---|---|---|---|---|---|---|
| Sample | Ethanol | H₂O | NH₄OH | TEOS | TMSPU | [TMSPU] | diameter |
| number | (mL) | (mL) | (mL) | (mL) | (mL) | (% w/w) | (nm) |
| 1 | 23.5 | 0.4 | 0.7 | 0.72 | 0.08 | 9:1 | 33 ± 4.2 |
| 2 | 23.5 | 0.4 | 0.7 | 0.64 | 0.16 | 4:1 | 283 ± 51 |
| 3 | 23.5 | 0.4 | 0.7 | 0.4 | 0.4 | 1:1 | aggregates |
| 4 | 23.5 | 0.4 | 1 | 0.8 | 0.16 | 5:1 | 98 ± 17.6 |
| 5 | 23.5 | 0.4 | 1 | 0.8 | 0.25 | 3.2:1 | 115 ± 11.2 |

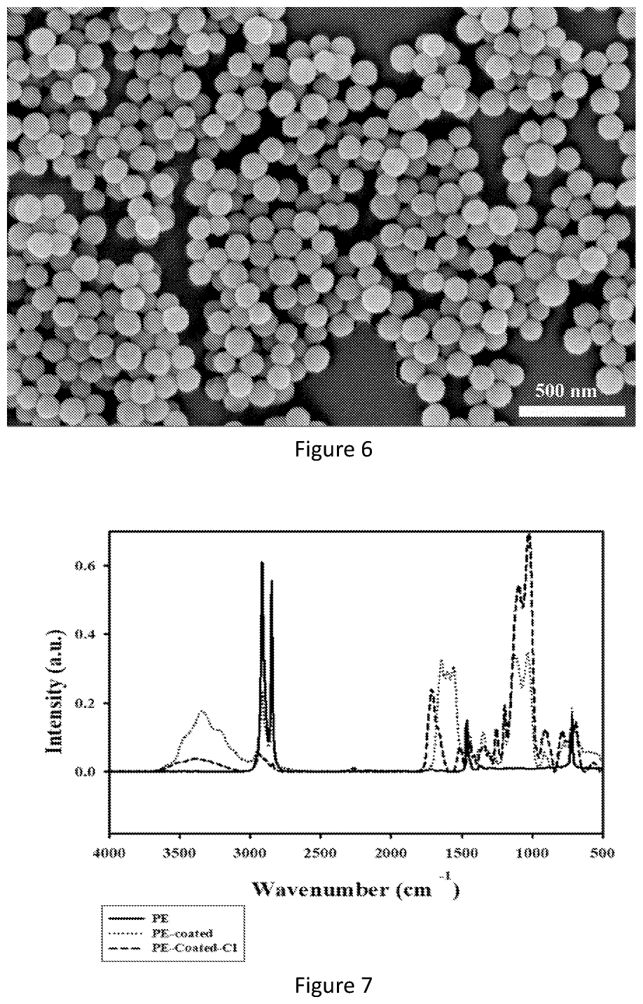

For illustration, FIG. 6 exhibits HR-SEM image of the core/shell SiO₂-urea particles (Table 8, example 4). Table 8 clearly shows that the average diameter of the N/MPs depended on the weight ratio of [TEOS]/TMSPU], increasing this ratio will lead to decrease in the particles' diameter. FIG. 6 shows that these particles possess a spherical shape and narrow size distribution.

### Example 2

### Characterization of the Silica-Urea Coatings

### Attenuated Total Reflectance (ATR)

ATR spectra were recorded to verify the polymerization process and halogenation of the SiO₂-urea coatings. FIG. 7 presents the ATR spectrum of the PE (Solid line) and PE/SiO₂-urea coatings before (Dotted line) and after (Dashed line) the chlorination process.

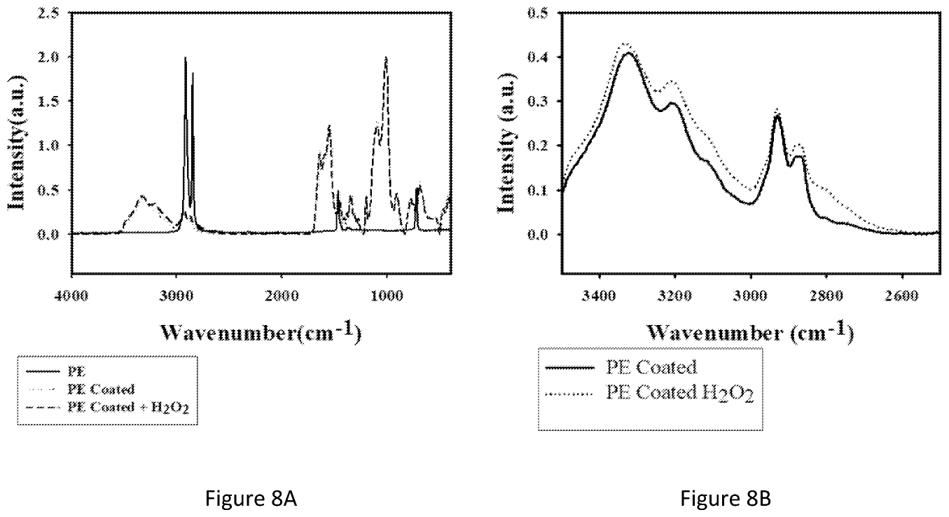

FIG. 8A presents the ATR spectrum of the PE/SiO₂-urea coating before (Dotted line) and after the addition of hydrogen peroxide (Dashed line), FIG. 8B presents the zoom ATR spectrum in 2500-3600 cm⁻¹ comparing the spectrum before (Solid line) and after the addition of hydrogen peroxide (dotted line).

The interpretation of the PE film spectrum is known from the literature and includes peaks at 719, 1468, 2851 and 2920 cm⁻¹ are easily discernable in FIG. 7 (Solid line). Likewise, the Si—O—Si, SiOH, C═O and N—H of the urea peaks at 1132, 1041, 1657 and 3348 cm⁻¹, respectively as seen in FIG. 8 (Dotted line). FIG. 7 (Dashed line), representing the PE/SiO₂-urea-Cl, illustrates the same peaks as in FIG. 8 (Dotted line) except for the peak at 3195 cm⁻¹, which has nearly disappeared and is replaced by a new peaks at 712 and 456 cm⁻¹ corresponding to the newly formed N—Cl bond. FIG. 10B introduce close up of the unique —OH stretching on 2830 cm⁻¹ to hydrogen peroxide peak after the addition of hydrogen peroxide to PE-SiO₂-urea. The broader peaks between 2500 to 3600 cm⁻¹ support the higher concentration of hydrogen bonds, which may be contributed by the hydrogen peroxide complexation.

### Contact Angle (CA)

Sessile contact angles were measured on PE and PC films to determine hydrophilic/hydrophobic properties. Tables 9 and 10 show the CA of the films before and after chlorination and hydrogen peroxide addition. As demonstrated, after the chlorination stage the CA of the films increased in 20° and the films became hydrophobic, similar results obtained after the addition of H₂O₂.

TABLE 9
Contact angle measurements showing changes in surface energy before
and after chlorination of the PE/SiO2-urea and PC/ SiO2-urea films

| | | PE/SiO₂- | PE/SiO₂ | | PC/SiO₂ - | PC/SiO₂ |
|---|---|---|---|---|---|---|
| Sample | PE* | urea | urea-Cl | PC* | urea | urea-Cl |
| Contact | 70 ± 3 | 57 ± 4 | 89 ± 3 | 74 ± 2 | 69 ± 3 | 93 ± 4 |
| angle (°) | | | | | | |

*The PE and PC films were treated before coating with corona at 300 W · min/m².

TABLE 10
Contact angle measurements showing changes in
surface energy before and after hydrogen peroxide addition
to of the PE/SiO₂-urea films.

| Sample* | PE | PE/—SiO₂-urea | PE/SiO₂-urea-H₂O₂ |
|---|---|---|---|
| Contact angle | 95 ± 2 | 53 ± 2 | 73 ± 3 |
| (°) | | | |

*All the samples are PE films that prepared according to the procedure in Table 2, example 1 by spreading/rod-coating technique (Mayer rod 400 (Table 3). Hydrogen peroxide addition process was done at ~55° C.
*The PE films were treated before coating with corona at 350 Watts · min/m²

### Durability of SiO₂-Urea Coatings

The durability of the SiO₂-urea coating was tested in order to evaluate its viability for industrial applications. As stated in the methods section, the tape test was applied to a coated film a number of times then subsequently measured for surface contact angle and ATR. Al the films shows the same CA and ATR peaks. This demonstrates the durability of the SiO₂-urea coatings which is due both to the strong crosslinked network of Si—O—Si bonds belonging to the SiO₂-urea coating and the bond between the functional surface groups of the film and the SiO₂-urea coatings.

### Determination of Bound Chlorine to the Particles and Coatings

The Cl content that bound to the coatings or particles were determined by iodometric/thiosulfate titration as mentioned. All the different particles and coatings showed bonding of Cl. The various concentrations in the bonding of Cl have been affected in a variety of ways: first, in the preparation process of the particle or coatings, the type of film on which the coatings were made, the concentration of monomers, bleach concentration and time, and the thickness of the coating.

### Determination of the Adduct Hydrogen Peroxide Belonging to the SiO₂-Urea N/MPs and Coatings

The concentration of hydrogen peroxide that bound to the coatings were determined by KMnO₄ redox titration as mentioned. The various concentrations in the bonding of hydrogen peroxide have been affected in a variety of ways: the thickness of coating, reaction temperature, reaction time and the hydrogen peroxide solution concentration used as precursor.

### Effect of Monomer (Trimethoxysilyl)Propyl] Urea, TMSPU) Concentration on the Cl Concentration Bonded to the SiO₂-Urea N/MPS and Coatings

As demonstrated in Table 11, there is a direct effect between the concentration of TMSPU used for preparing the coating and the bound Cl concentration to the SiO₂-urea coating. High concentration of the monomer leads to increase in the bound Cl to the N/MPs and the coatings. Table 11 shows improvement in the Cl concentration for PE films prepared according to Table 2, examples 1-4 by spreading/rod-coating technique (Mayer rod 4 (Table 3). The chlorination process was done at bleach concentration of 0.5%.

TABLE 11
Effect of the monomer (trimethoxysilyl)propyl]
urea, TMSPU) concentration on the Cl concentration
bonded to the PE/SiO₂-urea coatings

| | TMSPU volume | TMSPU concentration | [Cl] |
|---|---|---|---|
| Sample* | (mL) | (w/v %) | (μmoles/1 cm²) |
| 1 | 1.5 | 6.6 | 1.35 |
| 2 | 0.75 | 3.3 | 0.6 |
| 3 | 0.5 | 2.2 | 0.37 |
| 4 | 0.125 | 0.55 | 0.15 |

*All the samples are PE films prepared according to the procedure in Table 2, examples 1-4 by spreading/rod-coating technique (Mayer rod 4 (Table 3). The chlorination process was done with 0.5% bleach for 12 h in 25° C.

Addition of hydrogen peroxide done with coated films prepared in presence of 6.6 w % TMSPU, since, the sample provided the highest bound chlorine content, hence, the assumption is that this sample contain the highest concentration of functional urea groups.
Effect of the SiO₂-Urea Coating Thickness on the Cl Concentration Bonded to the SiO₂-Urea Coatings

Table 12 illustrates a direct effect between the thickness of the SiO₂-urea coating and the Cl concentration bonded to the SiO₂-urea coatings. Higher thickness leads to an increase in the bound Cl to the coatings. Table 12 shows improvement in the Cl concentration for PE films that prepared according to the procedure in Table 2, example 1 by spreading/rod-coating technique (Table 3) and the chlorination process was done with 0.5% bleach.

TABLE 12
Effect of the SiO₂-urea coating thickness on the
Cl concentration bonded to the SiO₂-urea coatings

| | Wet Film Deposit | [Cl] |
|---|---|---|
| Sample ^{A, B} | (μm) | (μmoles/1 cm²)) |
| 1- M₁ | 6 | 0.22 |
| 2- M₄ | 40 | 0.3 |
| 3- M₆ | 60 | 1.05 |
| 4- M₂₀₀ | 200 | 1.5 |
| 5- M₄₀₀ | 400 | 3 |

^{A} M—Mayrod number
^{B} All samples are PE films that prepared according to the procedure in Table 2, example 1 by spreading/rod-coating technique (Table 3) and the chlorination process was done with 0.5% bleach for 12 h in 25° C.

Effect of Coating Thickness on the H₂O₂ Concentration Bonded to the SiO₂-Urea Coatings

Table 13 illustrates a direct relationship between the thickness of the SiO₂-urea coating and the hydrogen peroxide content bonded to the coatings. Higher coating thickness leads to an increase in the hydrogen peroxide concentration bonded to the coatings.

TABLE 13
Effect of coating thickness on the H₂O₂ concentration
bonded to the SiO₂-urea coatings

| | | Wet film deposit | H₂O₂ |
|---|---|---|---|
| Sample^{A, B} | Number of layers | (μm) | (μmoles/14 cm²) |
| 1-M6 | 1 | 6 | 4.4 |
| 2-M400 | 1 | 400 | 8.3 |
| 3-M400 | 2 | 800 | 44.3 |
| 4-M400 | 3 | 1200 | 79.5 |

^{A}M—Myrod number
^{B}All the samples are PE films that prepared according to the procedure described in Table 2, example 1 by spreading/rod-coating technique (Mayer rod varied thickness (Table 3)) and the Hydrogen peroxide addition process was done at ~55° C.

Table 14 illustrates a direct relationship between the H₂O₂ precursor concentration and the hydrogen peroxide bonded to the SiO₂-urea coating. Higher H₂O₂ concentration solution leads to significant increase in the hydrogen peroxide bonded to the coating.

TABLE 14
Effect of the precursor H₂O₂ concentration on the
H₂O₂ concentration bonded to the SiO₂-urea coatings.

| | precursor H₂O₂ aqueous solution | |
|---|---|---|
| | concentration | |
| Sample* | (% w/w) | H₂O₂ (μmoles/14 cm²) |
| 1 | 7.5 | 22.6 |
| 2 | 15 | 50.2 |
| 3 | 30 | 67.5 |

*All the samples are PE films that prepared according to the procedure in Table 2, example 1 by spreading/rod-coating technique (Mayer rod 400 (Table 3)) and the Hydrogen peroxide addition process was done at ~55° C.

### Effect of the Chlorination Parameters

Following the synthesis of the optimal SiO₂-urea particles and coatings, the effect of varying the chlorination process parameters were investigated, e.g., sodium hypochlorite concentration, duration time and temperature. All of these parameters are known to influence the chlorine linkage to the N/MPs or coatings.

### Effect of NaOCl Concentration on the Cl Content Bonded to the SiO₂-Urea Particles and Coatings

To characterize the effect of sodium hypochlorite (NaOCl) concentration on the SiO₂-urea particles and coatings, the inventors used increasing concentrations of NaOCl as presented in Table 15. Table 15 illustrates that, as expected, increasing the NaOCl concentration leads to an increase in the bound Cl loading of the particles and coatings. This Table related to PE films prepared according to Table 2, example 1 with May rod number 6. However, same results were obtained for all various coatings and N/MPs.

TABLE 15
Effect of NaOCl concentration on the Cl content
of the produced SiO₂-urea-Cl coatings

| | [NaOCl] | [Cl] |
|---|---|---|
| Sample* | (W/W %) | (μmoles/1 cm²) |
| 1 | 0.1 | 0.45 |
| 2 | 0.5 | 1.05 |
| 3 | 2.5 | 2.1 |
| 4 | 5 | 4.5 |

*All the samples are PE films that prepared according to the procedure in Table 2 Examples 1by spreading/rod-coating technique (Mayer rod 6 (Table 3)) and the chlorination process was done at 25° C. for 12 h.

### Effect of the Chlorination Time on the Cl Content of the Produced SiO₂-Urea-Cl Coatings

In addition, the inventors tested the effect of the chlorination time on the Cl content of the produced SiO₂-urea-Cl coatings, as demonstrated in Table 16. This Table illustrates that increasing the chlorination duration from 5 min to 12 h leads to increased Cl content in the produced coatings from 0.75 mM to 4.5 mM. However, the main increase in the Cl content was in the first 30 min.

TABLE 16
Effect of chlorination time on the Cl content
of the produced SiO₂-urea-Cl coatings

| | Chlorination time | Cl concentration |
|---|---|---|
| Sample* | (min) | ((μmoles/1 cm²)) |
| 1 | 5 | 0.75 |
| 2 | 30 | 1.5 |
| 3 | 60 | 2.3 |
| 4 | 720 | 4.5 |

*All the samples are PE films that prepared according to the description in Table 2, Example 1by spreading/rod-coating technique (Mayer rod 400 (Table 3)). The chlorination process was done at 25° C.

Effect of the Reaction Time on the H₂O₂ Content of the Produced SiO₂-Urea-H₂O₂ Coatings

Table 17 illustrates that the main H₂O₂ charging occurs within the first 5 min, increasing the reaction duration time from 5 min. to 30 min. and overnight resulted in decrease of the H₂O₂ content of the SiO₂-urea-H₂O₂ coatings from 44.3 to 36.3 and 0 μmoles/14 cm², respectively.

TABLE 17
Effect of the reaction time on the H₂O₂
content of the produced SiO₂-urea-H₂O₂ coatings

| Sample* | Reaction time | H₂O₂ (μmoles/14 cm²) |
|---|---|---|
| 1 | ~5 min | 44.3 |
| 2 | ~30 min | 36.3 |
| 3 | overnight | 0 |

*All the samples are PE films that prepared according to the procedure in Table 2 Examples 1 by spreading/rod-coating technique (Mayer rod 400 (Table 3)) and the Hydrogen peroxide addition process was done at ~55° C.

Effect of Reaction Temperature on the H₂O₂ Content of the Produced SiO₂-Urea-H₂O₂ Coatings.

Table 18 demonstrates two temperatures 25 and 55° C. that were tested for loading H₂O₂ to the SiO₂-urea coating. This Table clearly illustrates that the H₂O₂ loading at the higher temperature (55° C.) resulted in significantly higher content of H₂O₂ in the produced SiO₂-urea-H₂O₂ coating compared to the lower temperature (25° C.). According to literature, hydrogen peroxide rapid decompose over 82° C. and the complexation of urea hydrogen peroxide done just below 60° C., the test above, examine 2 possible temperature reactions, and clearly preferably temperature, just below 60° C., in order to obtain the higher amount of bonded H₂O₂.

TABLE 18
Effect of reaction temperature on the H₂O₂
content of the produced SiO₂-urea-H₂O₂ coatings.

| Sample* | Reaction temperature(° C.) | H₂O₂ (μmoles/14 cm²) |
|---|---|---|
| 1 | ~55 | 61.4 |
| 2 | ~25 | 22.2 |

*All the samples are PE films prepared according to the procedure in Table 2, example 1 by spreading/rod-coating technique (Mayer rod 400 (Table 3)). The Hydrogen peroxide addition to the SiO₂-urea process was done at ~55° C. and in room temperature.

### Effect of Cl Charging/Re-Charging Cycles on the Cl Content of the SiO₂-Urea-Cl Coatings

The renewability of SiO₂-urea-Cl coatings was evaluated for five cycles, as described in the experimental section. Table 19 illustrates that the bound Cl content of the coating at each cycle was similar to that in the first cycle after the chlorination step was completed. This result proves the effective re-chargeability of these crosslinked N-halamine coatings. The table shows the results of the PE film that prepared according to the Table 2 Example 1 with May rod number 6 and the chlorination process was done at 0.5%.

TABLE 19
Effect of Cl charging/re-charging cycles on
the Cl content of the SiO₂-urea-Cl Coatings

| | [Cl] concentration |
|---|---|
| Cycle number* | (μmoles/1 cm²) |
| 1 | 1.05 |
| 2 | 1.00 |
| 3 | 1.05 |
| 4 | 1.00 |
| 5 | 1.05 |

*The Table shows the results of the PE film that prepared according to Table 2, example 1 with Mayer rod number 6 and the chlorination process was done with 0.5% bleach.

### Example 3

Antibiofilm Properties of the Non-Chlorinated and Chlorinated SiO₂-Urea Coatings onto Polymeric Films

The inventors studied the ability of chlorinated coatings to prevent fouling. For this purpose, non-chlorinated (control) and chlorinated PE-SiO₂-urea films were mixed with contaminated aqueous solution belonging to Hazerim, Netafim Ltd field study facility. After one month of incubation in this contaminated water, the inventors saw that the chlorinated films (PE/SiO₂-urea-Cl) stayed clean as opposed to the non-chlorinated films ((PE/SiO₂-urea), which had substantial fouling on it. A few of the non-chlorinated and chlorinated treated films were collected for further investigation in the lab. In the lab, the samples were sonicated and the extracts were sent for Total Organic Carbon (TOC) analysis at Aminolab Ltd (Rehovot). The results showed that the control samples had 200 mg/L while only 2.5 mg/L carbon was quantified in the extract of the chlorinated films, suggesting the chlorinated coatings protect the films and prevent the accumulation of organic materials on it.

Similar results were observed by substituting the PE film for other films, e.g., PP, PC, PS, PMMA, PVC, PET, as well as metal oxides, e.g., iron oxide, titanium and aluminum oxide.

### Example 4

### Biological Results

### Effects of the Chlorine and Essential Oil Coatings on the Development of Microorganisms (Viruses, Mold, Pests, Etc)

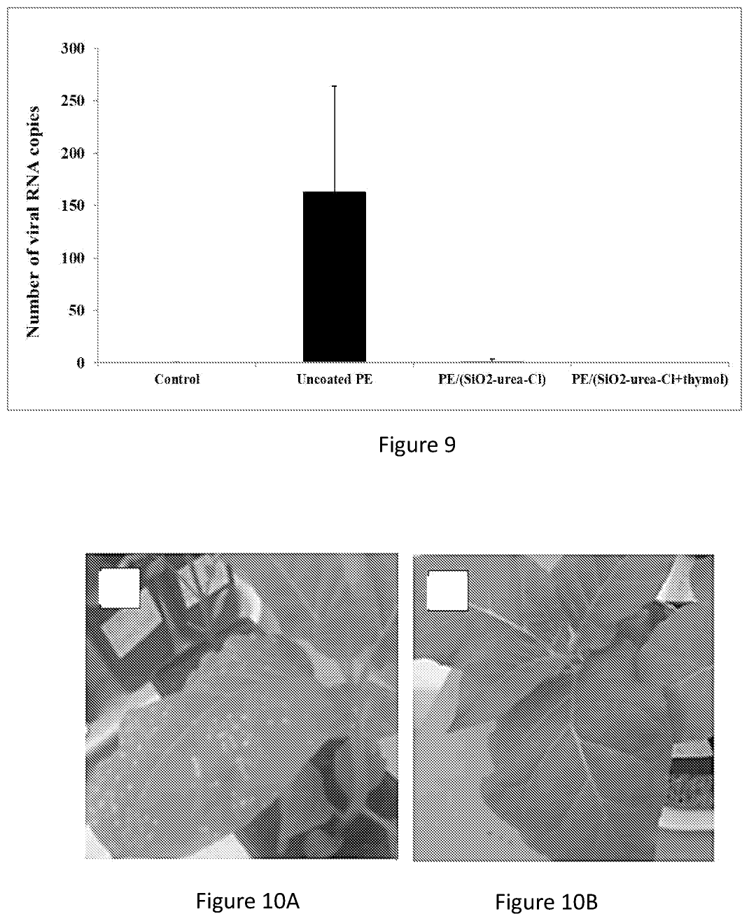

The experiment was performed on 100 FFU of the Hepatitis C Virus (HCV). Both the non-chlorinated, the chlorine-releasing and chlorine/thymol-releasing coatings were incubated together with HCV for one hour. A control experiment was done in the absence of the virus. The following graph demonstrates the ability of the coatings to kill the HCV. Activated Cl-releasing coatings managed to kill close to 100% of HCV while the combined coating consisting of thymol oil and chlorine-releasing showed no viral RNA copies, indicating that all HCV viruses were killed by the synergistic coating (FIG. 9).

Similar results were observed by substituting the PE film for other films, e.g., PP, PC, PS, PMMA, PVC, PET, aluminum oxide, iron oxide and titanium.

Similar antibiofilm properties were obtained against bacteriophages viruses, using viral plaque quantification which was performed as follows: phages were placed on the treated films (PE, PE/thymol, PE/SiO₂—Cl and PE/SiO₂—Cl-thymol films for 3 h at room temperature, after which the phages were removed from the films and seeded onto a layer of bacteria to form bacterial plaques. The plaques were then quantified and viable bacteria were extrapolated from these results. Here again PE and PE/thymol films did not show any significant activity while the activated Cl-releasing coatings (PE/SiO₂-urea-Cl) managed to kill about 90% of HCV while the combined coatings (PE/(SiO₂-urea-Cl+thymol) showed no viral RNA copies, indicating that all HCV viruses were killed by these synergistic coatings.

### Effects of the Chlorine and Essential Oil Coatings on the Development of Viruses in Plants

Effectiveness test of SiO₂-urea-Cl and SiO₂-urea-Cl-thymol and SiO₂-urea-thymol coatings onto oxidized PP films and PS boards against the spread of Tomato brown rugose fruit virus (ToBRFV) on tobacco plants has also been demonstrated.

The tests were done by direct contact between the virus and the non-coated and coated oxidized PP films and polystyrene (PS) boards. Shortly, the difference coatings were inoculated with 0.5 mL ToBRFV solution in direct contact for 24 h in room temperature. In the next step, 1 mL of phosphate buffer (0.01M, pH-7) extraction solution was added to the exposed virus solution. The tobacco plants leaves were sprayed with silicon carbide (Carborundum). 3 leaves of each plant were rubbed in the direction of its arteries. This procedure injured the plants leaves enabling the penetration of the virus. 100 μl of the virus solution was introduced to each selected leaf and was rubbed on the direction of its arteries. Bio-assay of the plants were measured via local lesions (LLs) count. LLs are formed due to the hypersensitivity of the tobacco plants to the ToBRFV. The virus causes the plant to activate apoptosis around the virus infection resulting in a programmed local cell death. The cell death is expressed by white lesions on the leaves. LL (local lesions) appearance occurred between 3-4 days after the virus infection. Each LL was counted as an infecting virus, as shown in Table 20 and FIG. 10.

TABLE 20
ToBRFV bio assay of pre infected tobacco seedlings.
LLs were counted for each coatings sample

| | | ToBRFV- Bio assay |
|---|---|---|
| Sample number | Sample type | No. local lesions (LL) |
| 1 | PP | >100 |
| 2 | PP/SiO₂ -urea | >100 |
| 3 | PP/SiO₂ -urea-Cl | 0LL |
| 4 | PP/SiO₂-urea-Cl -thymol | 0LL |
| 5 | PP/SiO₂-urea -thymol | 32 LL |
| 6 | PS/Silastol* 1% | 38 LL |
| 7 | PS/SiO₂-urea-Cl | 1 LL |
| 8 | PS/SiO₂-urea-Cl -thymol | 0.5LL |
| 9 | PS/SiO₂-urea-thymol | 32 LL |

*Silastol is a trademark of SCHILL & SEILACHER GmbH, Germany. It's used in the industry for a wide field of nonwoven in hygiene, food, and technical nonwoven such as diapers, blankets, face masks.

Silastol products intended for fabrics made of PP, PS and PE. Silastol helps for enhanced absorption of liquids. In this research the inventors use Silastol to make the surface of PP fabrics and PS boards more hydrophilic for better binding of the silane liquids.

The results (Table 20 and FIGS. 10A-B) indicate almost complete killing effect of the virus exposed to the SiO₂ Urea-Cl or SiO₂ Urea-Cl-thymol coatings. On the other hand, SiO₂-urea coatings (control) onto non-oxidized and oxidized PP films and PS boards did not affect the virus viability, while ToBRFV exposed to the SiO₂-urea-thymol coatings show a significant decrease in the percentage of infection (50%) but there are still enough viable viruses to infect the tobacco seedlings. The control tobacco seedling (FIG. 12A) exhibited expansive spreading of LLs. The seedling infected with the virus exposed to the PP/SiO₂-urea-Cl coating (FIG. 12B) exhibited healthy leaves with no signs of LLs.

### Effect of Essential Oil Coatings on the Development of Mold on Plants

0.4 gram of inflorescence Cannabis stevia were wrapped by PE/SiO₂-urea films and by PE/SiO₂-urea-thymol or PE/SiO₂-urea-arginol films (as described in Table 6) and placed then in a petri dish containing 1 ml of water. The petri dish was kept above 80% humidity for several weeks. The inflorescence was checked every 4 days for mold development. Table 6 shows the different compositions of the prepared coatings.

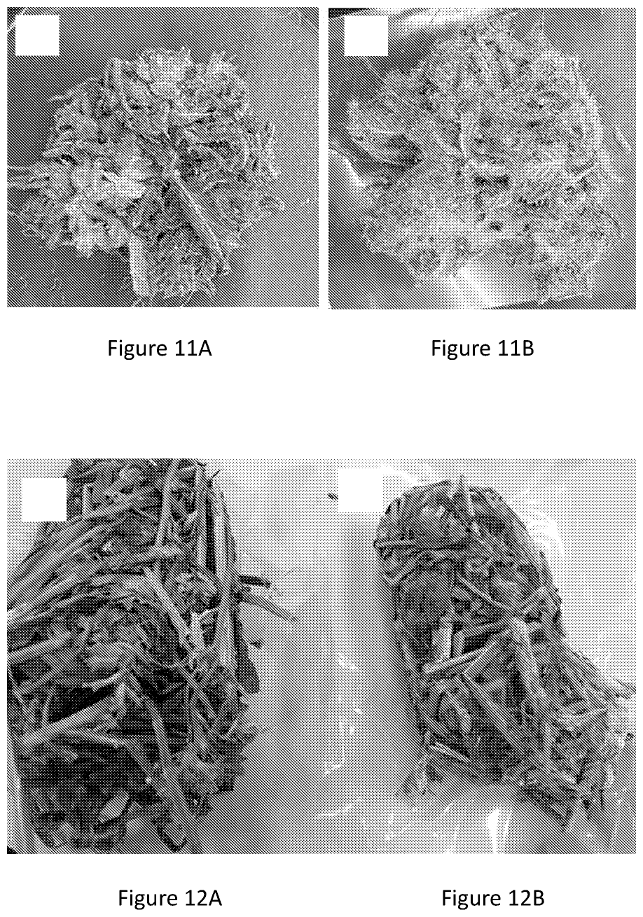

As demonstrated in FIGS. 11A-B the inflorescence Cannabis that were wrapped with the coating releasing thymol or arginol (A) did not develop mold compared to the non-coated film (B) for four weeks, while the control films PE/SiO₂-urea (as well as non-coated PE films).

Similarly, to the Cannabis stevia, mold development on hay was significantly decreased when wrapped with PE/(SiO₂-urea-Cl) films as compared to PE film for two weeks, as shown in FIGS. 12A-B.

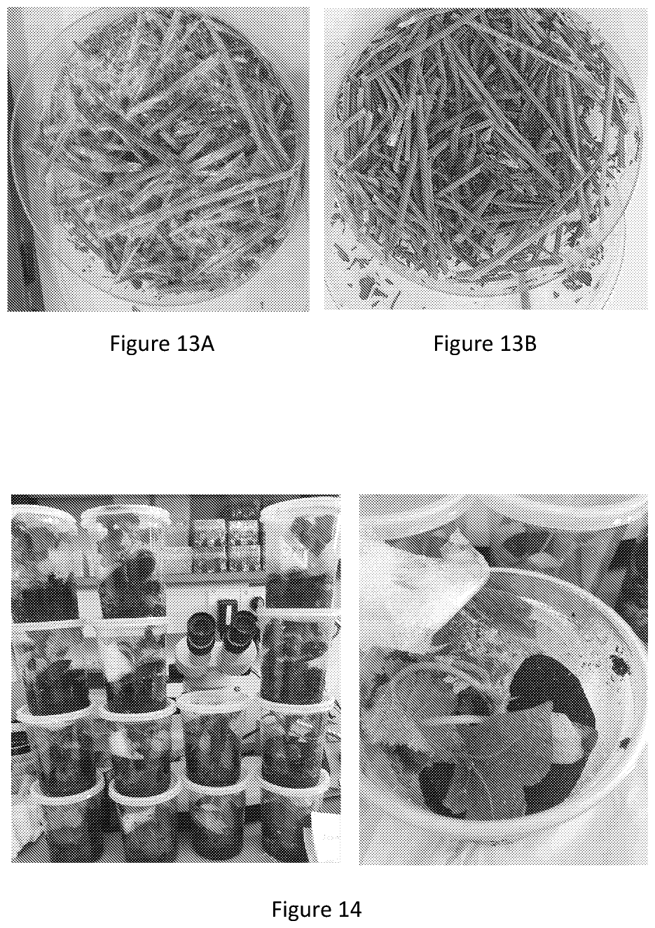

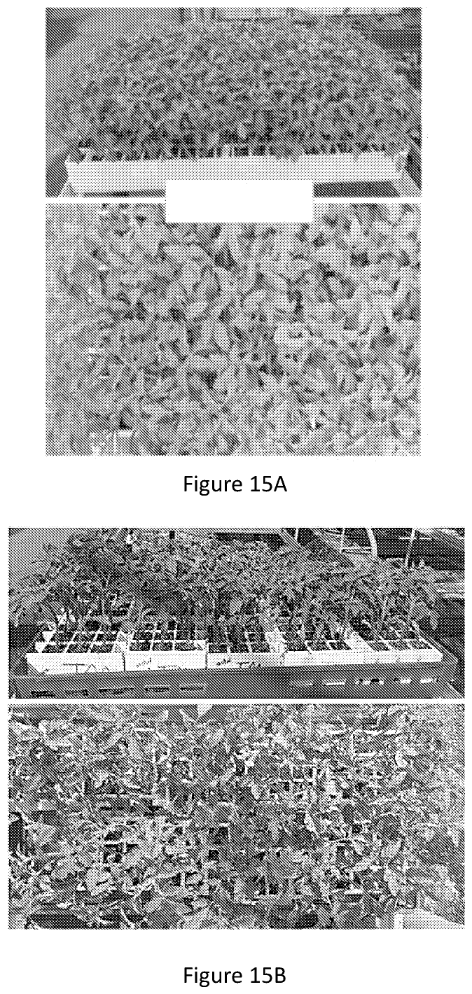

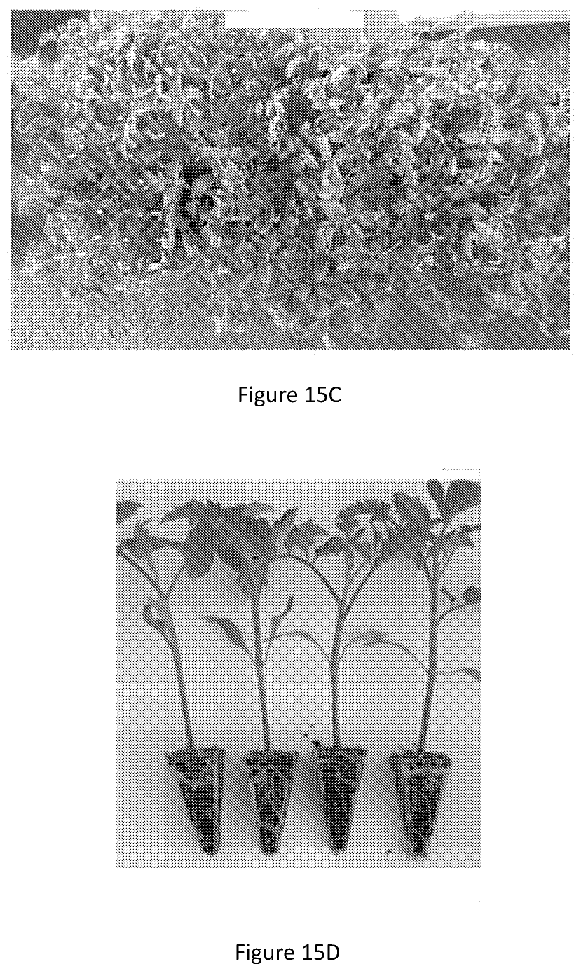

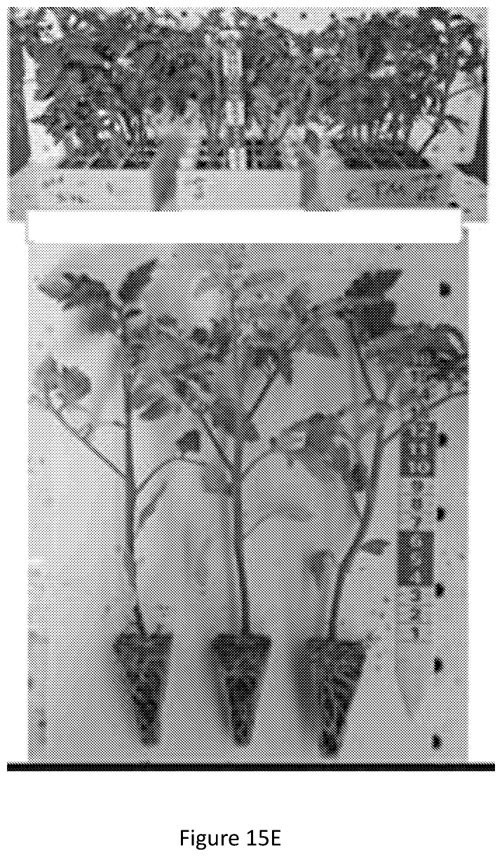

In addition, PP fabrics from AVGOL Ltd were coated by SiO₂-urea with different concentrations of thymol (Table 21). PP fabrics were first treated via the dipping method with the surfactant Silastol 1% and then coated according to the parameters mentioned in Table 2, sample 1 with the addition of thymol in varying concentrations. The coatings were delivered to TAMA Plastic Industry Ltd. to test activity against molds in hay. Briefly, 3 grams of hay were placed in a petri dish and soaked in 6 gr of water to simulate moisture conditions that would encourage mold growth. The different coated PP fabrics were placed above or below the hay then inserted to an incubator with 30° C. and 60% humidity for 10 days, all 3 days the plates were weighed and the amount of dried water was added (Table 21, FIG. 13).

TABLE 21
Effect of thymol coatings on the development of mold on hay

| | | Mold |
|---|---|---|
| Sample* | composition | development |
| 1 | Control | + |
| | (non-oxidized and Silastol treated | |
| | PP films | |
| 2 | PP/SiO₂-urea | + |
| | control | |
| 3 | PP/SiO₂-urea-thymol 10% | − |
| 4 | PP/SiO₂-urea-thymol 2% | + |

*PP fabrics were prepared according to the procedure in Table 2, example 1 by dipping' while thymol was added during the proses of the coating.

The results (Table 21 and FIGS. 13A-B) for SiO₂-urea-thymol 10% coating exhibited no mold developed at all and the hay remained uninfected while the control (PP) exhibited mold throughout the hay.

### Effect of Essential Oil Coatings on Killing Pests (Insects, Etc)

PP fabrics from AVGOL Ltd were coated by SiO₂-urea with different concentrations of thymol, 1 and 2% (Table 22). PP fabrics were first treated via the dipping method with the surfactant Silastol 1% and then coated according to the parameters mentioned in Table 2, sample 1 with the addition of 1 and 2% thymol. The coatings activity against insect pests for different plants were then tested. Briefly, Small plants of cucumbers and zucchini were placed in a beaker (FIG. 14). Insects such as silverleaf whitefly (Bemisia tabac), a leaf aphid, and Pseudococcidae, a floury aphid, were then placed on the leaves. Coated PP fabrics were then placed in the beakers, see FIG. 14. The beakers were placed in refrigeration (6° C.). After 12 hours the boxes were placed in room temperature for 3 hours after which the viability of the insects was tested and determined.

TABLE 22
Effect of thymol coatings on the viability of insects

| | | Viability of the | |
|---|---|---|---|
| | | silverleaf | Viability of the |
| Sample* | composition | whitefly | Pseudococcidae |
| 1 | control | + | + |
| 2 | PP/SiO₂-urea control | + | + |
| 3 | PP/SiO₂-urea-thymol 1% | − | + |
| 4 | PP/SiO₂-urea-thymol 2% | − | + |

*PP fabrics were prepared according to the procedure in Table 2, example 1 by dipping, thymol was added during the process of the coating.

The results (Table 22) for SiO₂-urea-thymol 1% and 2% coatings exhibited 99-100% killing of the leaf aphids, but no killing of the floury aphids, while the control (PP fabric) exhibited complete viability of both, the leaf and floury aphids.

### Phytotoxicity Tests

Polypropylene and polystyrene trays were coated by SiO₂-urea-Cl and/or SiO₂-urea-thymol 1%. Tomato and broccoli seedlings were planted inside the coated trays (FIG. 17) and let grow under greenhouse conditions. The seedlings root system and foliage were monitored daily by visual inspection for phytotoxicity. The test lasted for three weeks.

All the seedlings in the experiment presented with normal appearances in growth (regular green growth) and in the development of the root nodules. Every two days the seedlings were examined, the roots developed new white and normal roots. No negative effects were observed for the silica-urea coatings without and with the chlorine or thymol 1% on the tomato seedlings. Similar results were observed for the broccoli seedlings. In addition, no negative effects were observed for the silica-urea-thymol (up tp 15% thymol) coatings in a non-contact situation, where the seedlings were not in direct contact with the coating films and exposed to thymol vapours only.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A coated substrate comprising: a substrate, and a silane-based polymer having a binding affinity to a biocide, wherein:
i) said silane-based polymer is covalently bound to at least a portion of said substrate, forming a coating layer; and
ii) said silane-based polymer is represented by or comprises Formula I: 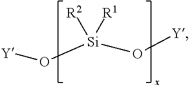
wherein:
x represents an integer between 2 and 10.000;
each Y′ independently represents H or a covalent bond to the substrate;
R² comprises any of: a urea functional group, and a urea derivative;
R¹ represents hydrogen, or is selected from the group comprising 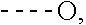
optionally substituted C₁-C₆ alkyl, —O(C₁-C₆ alkyl), —OH, or a combination thereof; [symbol]
represents a covalent bond to i) the substrate, or ii) to an adjacent monomer;
wherein said coating layer is a mesoporous coating layer; and
wherein the silane-based polymer comprises at least one covalent bond to the substrate; and wherein said substrate comprises an at least partially oxidized surface comprising a plurality of hydroxy groups.

2. The coated substrate of claim 1, wherein said binding affinity is via formation of a covalent bond, a coordinative bond or a non-covalent bond between said biocide and said urea functional group.

3. The coated substrate of claim 1, wherein R² is represented by or comprises Formula II: 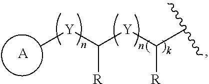
wherein:
A comprises said urea functional group, said urea derivative or both;
each Y independently represents a heteroatom, C, CH, CH₂, —CHR1-, —CR1R1-, or is absent;
the heteroatom is selected from the group consisting of O, S, NH, and NR1, or a combination thereof;
each n and k is a integer ranging from 0 to 10;
each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof, and wherein said urea derivative comprises an optionally deprotonated urea functional group bound to said biocide.

4. The coated substrate of claim 1, wherein said urea derivative comprises a urea metal complex, an n-halo urea, or any combination thereof.

5. The coated substrate of claim 1, wherein R² is represented by or comprises Formula IIa: 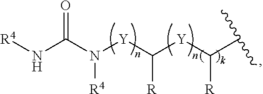
wherein:
each R⁴ independently represents hydrogen, halo, or —(CH)ₙSi(OR′)₃;
R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl; or
wherein R⁴ is absent, and the urea group is coordinatively bound to a metal cation.

6. The coated substrate of claim 1, wherein said silane-based polymer is represented by or comprises Formula III: 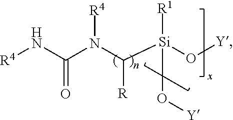
wherein n is an integer ranging from 1 to 5;
or Formula IV:

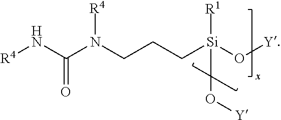

7. (canceled)

8. The coated substrate of claim 1, wherein said biocide comprises a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof; optionally wherein said essential oil is selected from the group comprising thymol, arginol, lemonene, cinammon oil, organum oil, sage oil, tea tree oil, carvacrol oil, or any combination thereof; further optionally wherein said antimicrobial metal ion is selected from the group comprising Zn²⁺, Cu²⁺ and Ag⁺ or any combination thereof.

9. (canceled)

10. (canceled)

11. (canceled)

12. The coated substrate of claim 1, wherein said coating layer is characterized by a dry thickness between 0.1 μm and 50 μm; optionally wherein said coating layer comprising at least two of said coating layers; optionally wherein said coating layer comprises an antimicrobial effective amount of said biocide.

13. (canceled)

14. (canceled)

15. The coated substrate of claim 12, wherein the antimicrobial effective amount comprises any of: (i) between 0.1 μmoles/1 cm² and 100 μmoles/1 cm² of chlorine; (ii) between 0.1 μmoles/1 cm² and 100 μmoles/1 cm² of H₂O₂ or both (i) and (ii); optionally wherein said coated substrate is characterized by a water contact angle on the surface of said coating layer between 40° and 110°.

16. The coated substrate of claim 1, wherein said coating layer comprises at least two distinct biocide species; optionally wherein said at least two distinct biocide species are selected from: (i) Cl and an essential oil and (ii) a metal ion and hydrogen peroxide at a weight per weight (w/w) ratio between 1:500 (w/w) and 1:2000 (w/w).

17. (canceled)

18. (canceled)

19. The coated substrate of claim 1, wherein said substrate is selected from the group consisting of: a polymeric substrate, a metallic substrate, a paper substrate a glass substrate, and any combination thereof; optionally wherein said polymeric substrate comprises a polymer selected from the group consisting of: polyethylene (PE), polypropylene (PP), polyethylene terephthalate (PET), PET derivatives, polymethylmethacrylate (PMMA), polystyrene (PS), polyvinyl alcohol (PVA), polycarbonate (PC), high-density polyethylene (HDPE), low-density polyethylene (LDPE), very low-density polyethylene (VLDPE), polyester, polyvinyl chloride (PVC), polyacetal, cellulose, cellulose derivatives, poly(2-hydroxyethyl methacrylate) (pHEMA), nylon, and any combination thereof; optionally wherein said metallic substrate comprises a metal, a metal oxide or both.

20.-22. (canceled)

23. The coated substrate of claim 1, wherein said coating layer is configured to release an antimicrobial effective amount of said biocide to an ambient, and wherein said coating layer is any of: an antimicrobial coating, synergistic antimicrobial coating, antibiofilm coating, bacteriostatic coating, fungicidal coating, fungistatic coating, pesticide coating, antiviral coating, or any combination thereof.

24. The coated substrate of claim 1, wherein an outer surface of said coating layer is further bound to an additional coating layer being substantially gas impermeable, optionally wherein said additional coating layer is removable.

25. An article comprising the coated substrate of claim 1.

26. The article of claim 25, wherein said article is selected from the group consisting of: plastic surface, metallic surface, package, and windows.

27. A process for obtaining the coated substrate of claim 1, comprising the steps of:
(a) providing at least partially oxidized substrate comprising a plurality of hydroxy groups; and
(b) contacting said substrate with a composition comprising: (i) a silane-based monomer, wherein said silane-based monomer is represented by or comprises Formula V: 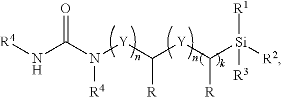
wherein:
each of R¹, R², R³ independently represents hydrogen, or is selected from the group comprising optionally substituted C₁-C₆ alkyl, —O(C₁-C₆ alkyl), —OH, or a combination thereof, wherein at least one R¹, R² or R³ represents said substituent; each R⁴ represents hydrogen, halo, or —(CH)ₙSi(OR′)₃, or wherein R⁴ is absent, and the urea group is coordinatively bound to a metal cation;
R′ is selected from hydrogen, methyl, alkyl, alkenyl, alkynyl, cycloalkyl, heteroalicyclic, aryl, heteroaryl, hydroxy, alkoxy, aryloxy, thiohydroxy, thioalkoxy, thioaryloxy, halide, amine, amide, carbonyl, thiocarbonyl, carboxy, thiocarboxy, epoxide, sulfonate, sulfonyl, sulfinyl, sulfonamide, nitro, nitrile, melamine, isonitrile, thiirane, aziridine, nitroso, hydrazine, sulfate, azide, phosphonyl, phosphinyl, urea, thiourea, carbamyl and thiocarbamyl;
each Y independently represents a heteroatom, C, CH, CH₂, —CHR1-, —CR1R¹—, or is absent; the heteroatom is selected from the group consisting of O, S, NH, and NR1, or a combination thereof;
each n and k is a integer ranging from 0 to 10; and
each R independently represents hydrogen, or is selected from the group comprising —OH, —C(═O), halogen, optionally substituted C₁-C₆ alkyl, —NH₂, an optionally substituted aromatic ring, a fused heteroaromatic ring, optionally substituted heterocyclyl, or any combination thereof; and
(ii) a solvent, a surfactant or both, under conditions suitable for said silane-based monomer to polymerize and covalently bound to said substrate, thereby forming a coating layer on said substrate.

28. The process of claim 27, further comprising a step of contacting said coating layer with a biocide comprising a halogen selected from chlorine (Cl), bromine (Br) and iodine (i), hydrogen peroxide (H₂O₂), a hydrogen peroxide source, a peroxide, a peracid, an essential oil, an antimicrobial metal ion, or any combination thereof.

29. (canceled)

30. The process of claim 27, further comprising a step (c) of washing the substrate to remove non-bound silane-based monomer, optionally wherein said contacting is selected from the group comprising: dipping, spraying, spreading, casting, rolling, adhering, printing, curing, sonication, or any combination thereof.

31. (canceled)

32. The process of claim 27, wherein said silane-based monomer is represented by or comprises Formula VI:

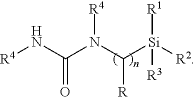

33. The process of claim 27, wherein said silane-based monomer is represented by or comprises any one of: 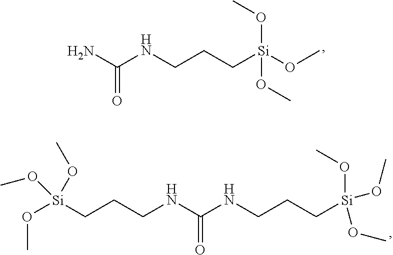
or both.

34.-61. (canceled)
